(19) United States
(12) Patent Application Publication
(10) Pub. No.: US 2011/0265134 A1
(43) Pub. Date: Oct. 27, 2011

(54) Switchable multi-channel data transcoding and transrating system

(76) Inventors: Pawan Jaggi, Plano, TX (US); Mark Daniel Fears, Plano, TX (US); Paul Byron Banta, Plano, TX (US); Xiaohui Wei, Plano, TX (US); James Richard Bartlett, Plano, TX (US)

(21) Appl. No.: 12/927,056

(22) Filed: Nov. 4, 2010

Related U.S. Application Data
(60) Provisional application No. 61/280,429, filed on Nov. 4, 2009.

(51) Int. Cl. H04N 21/234

(52) U.S. Cl. 725/109

(57) ABSTRACT

A video transport stream over IP (TS/IP) server system comprises a set of video server blocks. A video server block comprises a pair of codecs and a primary FPGA, the codecs based on a fully programmable high speed DSP processor. The video server block further comprises a pair of VioIP engines for translating transport streams into IP packet streams. The video TS/IP server can perform transcoding, transrating and statistical multiplexing functions between ingress and egress transport streams. The video TS/IP server can ingress or egress HD-SDI and DVB-ASI data streams to or from an IP network via TS/IP. A host subsystem is embedded in a stand-alone embodiment. Multiple video TS/IP servers can be hosted by a PC in a PC host embodiment.

### CROSS-REFERENCE TO RELATED APPLICATIONS

This application claims priority to U.S. Provisional Application No. 61/280,429 filed Nov. 4, 2009.

### TECHNICAL FIELD OF THE INVENTION

This invention relates to a system and method for encoding and decoding video signals to and from a video transport stream over IP. Video signals are typically MPEG-2 and H.264 compliant but may further include raw video ingress and egress via DVB-ASI and HD-SDI.

### BACKGROUND OF THE INVENTION

The challenges created by the ever evolving video encoding and transport standards force new generations of video equipment that video producers and distributors are required to manage, control and invest in. This is particularly true of distributers who provide high definition video to a large number of customers using a variety of encodings such as the MPEG-2 and H.264 standards, which are not compatible in bit-rate or in encoding technology. To manage in this environment, advanced but economical video compression techniques are required to transmit video. Furthermore, a dynamic platform is required to accommodate the ever evolving standards in order to reduce equipment churn.

Conventional approaches require complex ASICS or arrays of DSPs to manage the intensive signal processing. These approaches reduce flexibility, compromise quality and add non-recurring engineering costs inherent in ASIC production. What is needed is a high performance, high speed, low cost hardware platform in combination with software programmability so that future video signal processing standards may be incorporated into the platform as those standards evolve.

Traditionally, satellite broadcast systems have sent compressed video signals to cable television stations for redistribution using cable TV head-ends using related point to multipoint hardware architectures. But with the increasing performance of the internet network and the internet protocol (IP) for transport of constant bit-rate signals such as video, customers are being offered new options including high definition television HDTV on-demand. In many cases, the video sources may be standard definition SDTV product which need to be converted. In other cases, the video sources may be in a streaming format such as MPEG-2, supporting compression for HD-TV broadcast transport at about 20 Mb/s. However, bandwidth limited IP networks that need to carry multiple HDTV signals suffer congestion. It would be advantageous to convert the MPEG-2 video streams to H.264 standard video streams, that offer better compression efficiencies with bit-rates approximately 50% of MPEG-2. It would be also be advantageous to provide additional statistical multiplexing for IP transport of the lower bit-rate H.264 video streams.

U.S. Pat. no. 7,818,442 to Hershey et al. discloses a streaming media encoder for encoding media content. The media encoder has a confidence monitor for the input and output video data streams and a network interface.

U.S. Patent Patent Application Pub. No. 2008/0240093 to Morad et al. disloses a stream multiplexer/de-multiplexer for operating on packetized digital data streams including DVB receivers and DVB transmitters. The host interface for control can be a PCI, PCIe bus or Ethernet. The apparatus includes a central switch for switching data streams between various video and audio processors. The disclosure is primarily concerned with an architecture for a micro controller unit for video packet processing.

U.S. Patent Application Pub. No. 2009/0201988 to Gazier et al. discloses systems and methods for video processing in network edge devices. Gazier et al further disclose a method including decoding, transcoding and encoding a video stream into a specific format and disclose a system including multiple transcoder line cards connected to a switch fabric.

U.S. Patent Application Pub. No. 2008/0091845 to Mills et al. discloses a system and method for processing video content. The system of Mills et al. is concerned with moving content files and transcoding content files while in the process of moving them, although the modification of content files into a display of low bit-rate video streams is considered.

U.S. Patent Application Pub. No. 2006/0168637 to Vyotsky et al. discloses a multiple-channel codec environment that utilizes a plurality of reconfigurable media signal processors to provide on-demand network functions such as A/V transcoding.

The present invention addresses the need for a programmable video signal processor through a combination of a hardware and dynamic software platform for video compression and decompression processing suitable for broadcast level high definition (HD) video encoding, decoding and multiplexing. None of the above mentioned references provide a suitably modular hardware design that is realized at low cost and yet capable of software reconfiguration without considerable design effort. As there are varied needs within the media industry for video processing, in relation to video signal formats and applications, the present invention address the need for a modular video server component which may be resused in many different designs to meet a particular video processing requirement. The dynamic software platform is implemented on a low cost multicore DSP architecture that allows for easy reconfiguration of software to meet the video processing requirement.

### SUMMARY OF INVENTION

The present invention is a programmable codec system with sufficient flexibility to provide encoding, decoding and multiplexing functions in a plurality of application environments.

A video TS/IP server for transcoding and transrating is disclosed for transforming a set of input video streams from video sources into a set of output video streams for video destinations. The video TS/IP server is managed from a management console which accesses the video TS/IP server via a web enabled interface or a computer host via a PCI bus. The set of input video streams can include transport streams over IP with ingress from an IP network via Ethernet. The set of output video streams can include transport streams over IP with egress to an IP network via Ethernet. In an alternate embodiment, the video TS/IP server can encode uncompressed video streams directly from video applications into the set of output video streams, the uncompressed video streams being in the form of HD-SDI or DVB-ASI video streams. In another alternate embodiment, the video TS/IP server can decode the set of input video streams into uncompressed video streams and egress the uncompressed video streams directly to video applications, the uncompressed video streams being in the form of HD-SDI or DVB-ASI video streams. In the preferred embodiments, the transport streams include digital video formats MPEG-2, H.264, DV25 and DVC-pro/25/50/100.

The video TS/IP server comprises a set of video server blocks which may be configured to perform a variety of video processing functions. A video server block comprises at least two codecs, a primary FPGA, at least two VioIP processors, four Ethernet PHY interfaces and a set of supporting components including DDR memory, Flash memory and random-access memory. A first codec connects to the primary FPGA via a first set of data and control buses. The second codec connects to the primary FPGA via a second set of data and control buses. The first and second sets of data and control buses include a bidirectional bus for transporting uncompressed video streams, a bidirectional bus for transporting compressed video data streams, a bidirectional bus for transporting I2S audio data, and a bidirectional bus for peripheral data and control. Each VioIP processor connects to the primary FPGA via a bidirectional bus for transporting compressed audio and video (A/V) data streams. Flash memory containing program instructions for the codecs is attached to the primary FPGA. DDR memory is attached to each codec on which a set of video data buffers are implemented. A first Ethernet PHY interface is connected to a first VioIP processor. A second Ethernet PHY interface is connected to a second VioIP processor. A third Ethernet PHY interface is connected to the first codec. A fourth Ethernet PHY is connected to the second codec. The Ethernet PHY interfaces are terminated in RJ-45 connectors. A JTAG test CPLD is included for video server block debug activities.

The primary FPGA comprises a set of multiplexers and a pair of stream loaders. A first multiplexer selectably interconnects two input data and control buses suitable for compressed A/V data to two output data and control buses also suitable for compressed A/V data. A second multiplexer selectably interconnects two input data and control buses suitable for compressed A/V data to two output data and control buses also suitable for compressed A/V data. A third multiplexer selectably interconnects a flash memory interface to a first and second stream loader. The first stream loader is further connected to a first input data and control bus for uncompressed video data. The second stream loader is further connected to a second input data and control bus for uncompressed video data. The first and second stream loaders can be selectably configured to pass data from their respective input data and control bus or from the third multiplexer.

In a PCI-hosted video TS/IP server embodiment comprising a PCI host computer and a video server block, the video server block is augmented with a PCI bus driven by each of the two codecs. The PCI bus can be converted to a PCIe bus with a PCI to PCIe converter suitable to attach the video TS/IP server to the PC host computer. The primary FPGA can be configured by the PCI host computer via communication links between the codecs and the primary FPGA.

In another aspect of the invention, additional embodiments are realized by augmenting a video server block with a set of video and audio interfaces to transmit and receive uncompressed video streams.

A first video interface is a receiver for receiving uncompressed video data transmitted on a coaxiable cable connected to an adaptive cable equalizer to which an SDI receiver is connected. The output of the SDI receiver is connected to one of the codecs through a data and control bus.

The first video interface can be augmented with a multiplexer so that the SDI receiver is selectably connected to multiple codecs through multiple data and control buses.

A second video interface is a transmitter for transmitting uncompressed video data over a coaxiable cable connected to an SDI transmitter. The input of the SDI transmitter is connected to one of the codecs through a data and control bus.

The second video interface can be augmented with a multiplexer so that the SDI transmitter is selectably connected to multiple codecs through multiple data and control buses.

A first audio interface is a receiver for receiving uncompressed audio data transmitted on a suitable cable connected to an AES/EBU to I2S converter. The output of the AES/EBU to I2S converter is connected to at least one of the group of the first codec, the second codec and the primary FPGA.

A second audio interface is a transmitter for transmitting uncompressed audio data over a suitable cable connected to an I2S to AES/EBU converter. The input of the AES/EBU to I2S converter is connected to at least one of the group of the first codec, the second codec and the primary FPGA.

A stand-alone video TS/IP server embodiment comprises a set of N video server blocks, an Ethernet switch, an uncompressed video signal multiplexer, and a host processor. The host processor is further connected to a set of components including flash memory, random access memory, a set of status indicators, and a set of Ethernet ports. The uncompressed video signal multiplexer is an 2N port by 2N port digital bus multiplexer where any one of N/2 external inputs can be selectable connected to any one of N internal outputs and any one of N external outputs can be selectably connected to any one of N internal inputs. The N internal inputs and N internal outputs are connected to the set of video server blocks. A first set of 2N Ethernet ports are connected to the set of video server blocks for transmitting and receiving transport streams over internet protocol. A second set of 2N Ethernet ports are connected to the Ethernet switch block which is further connected to the host processor. A dual redundant power supply supplies power to the video TS/IP server and a set of cooling fans and includes a power button and power input connector.

The video TS/IP server includes a set of operable programs stored in flash memory and operated by a host processor and by the codecs comprising the video server block to selectably encode and decode audio and video data streams. The set of operable programs include a user interface, preferably a web application, usable to supply codec configurations for encoding and decoding tasks on the video TS/IP server. The set of operable programs include hardware drivers for the codecs to move data between the codec and other devices, including DDR memory and the set of data and control buses. The set of operable programs include communication, management and process functions to configure and control the encoding and decoding tasks. The set of operable programs include DSP related functions including intensive video processing that when executed operate on an input video/audio stream to transform it into an output video/audio stream according to the codec configurations.

The set of programs implement a set of methods for encoding and decoding video streams. A first method includes the steps of initiating the video server block, waiting for changes to the codec configurations to define encoding and decoding tasks, configuring the input and output video streams for processing according to the codec configurations, enabling the data flow of video streams on prescribed ports to and from the codecs, receiving a compressed audio/video data stream from an IP network as a transport stream and storing into a buffer, decoding the compressed audio/video data stream according to the codec configurations into a second buffer as an uncompressed audio/video data stream, encoding the uncompressed audio/video data stream into a second compressed audio/video data stream according to the codec configurations, and transmitting the second compressed audio/video data stream to an IP network as a transport stream.

These and other inventive aspects will be described in the detailed description below.

### BRIEF DESCRIPTION OF DRAWINGS

The disclosed embodiments will be described with reference to the accompanying drawings.

FIG. 1 is a schematic diagram of a video services application of the video TS/IP server system.

FIG. 2 is a schematic diagram of a second video'services application of the video TS/IP server system.

FIG. 3 is block diagram of the hardware configuration of a video server block of the video TS/IP server system.

FIG. 4 is a block diagram of the primary FPGA configuration.

FIG. 5 is a block diagram of a PCI hosted embodiment of the video TS/IP server.

FIGS. 6A-6H are block diagrams of additional hardware configurations for transmitting and receiving uncompressed audio/video signals from a video server block. FIG. 6A is a first receive configuration. FIG. 6B is a second receive configuration. FIG. 6C is a third receive configuration. FIG. 6D is a first transmit configuration. FIG. 6E is a second transmit configuration. FIG. 6F is a third transmit configuration. FIG. 6G is an audio receive configuration. FIG. 6H is an audio transmit configuration.

FIG. 7 is a block diagram of a hardware configuration for a stand-alone embodiment of a video TS/IP server system.

FIG. 8 is a block diagram of a software architecture for the video TS/IP server system.

FIG. 9 is a block diagram of the host software management processes.

FIG. 10 is a block diagram of the software components operating on the codec subsystem.

FIG. 11 is a state diagram of the codec subsystem.

FIG. 12 is a flow chart depicting a preferred embodiment of the main system function of a video TS/IP server.

FIG. 13 is a flow chart depicting a preferred embodiment of the initiation process of a video TS/IP server.

FIG. 14 is a flow chart depicting a preferred embodiment of the configuration process of a video TS/IP server.

FIG. 15 is a flow chart depicting a preferred embodiment of a process to enable the encoder and decoder operations of the codecs.

FIG. 16 is a sequence diagram depicting the preferred decoder method for decoding a compressed A/V stream into an uncompressed audio and video YUV data stream.

FIG. 17 is a sequence diagram depicting the preferred encoder method for encoding an uncompressed audio and YUV data stream into a transport stream containing compressed A/V data.

FIG. 18 is a sequence diagram depicting the an alternate embodiment decoder method for decoding a compressed A/V stream into an uncompressed audio and video YUV data stream.

FIG. 19 is a sequence diagram depicting an alternate embodiment encoder method for encoding an uncompressed audio and YUV data stream into a transport stream containing compressed A/V data.

### DETAILED DESCRIPTION

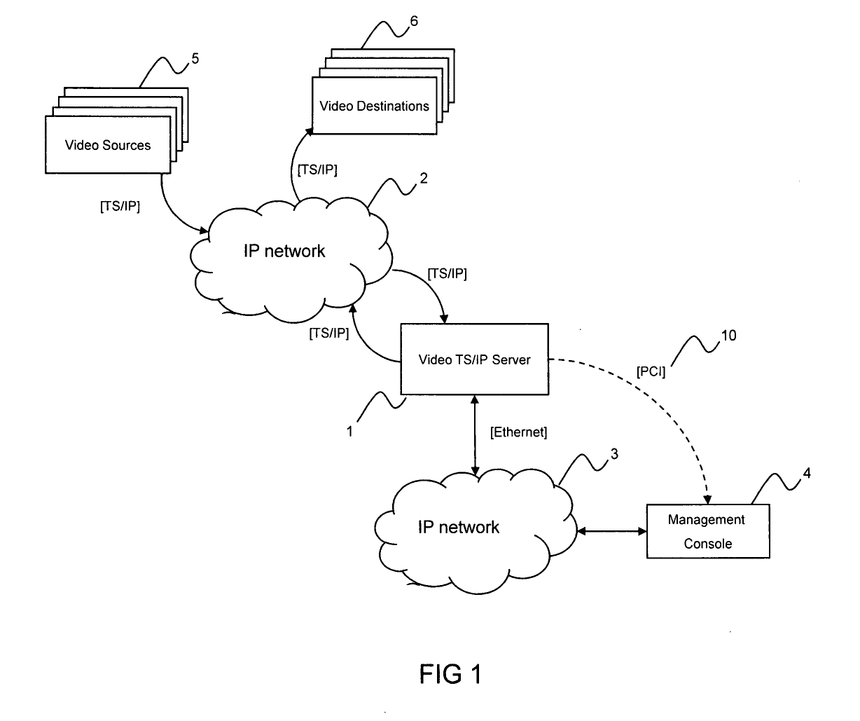

A first embodiment includes video distribution across an internet protocol (IP) network. In FIG. 1, video TS/IP server 1 is connected to IP network 2 and IP network 3. A set of video sources 5 and a set of video destinations 6 are connected to IP network 2. Management console 4 is connected to IP network 3 and in communication with the video TS/IP server. In operation, video data streams are encapsulated into a set of ingress transport streams by the set of video sources 5 and sent to video TS/IP server 1 via IP network 2 as TS over IP packet streams. The set of ingress transport streams are ingested by the video TS/IP server where they are transformed to a set of egress transport streams which are sent back out to IP network 2 as TS over IP packet streams addressed to one or more video destinations in the set of video destinations. Each transport stream of the set of egress transport streams is ingested by the video destination to which it is addressed.

Transport stream (TS) is a standard format for transmission and storage of audio, video, and data, and is used in broadcast systems. Transport Stream is specified in MPEG-2 Part 1, Systems (formally known as ISO/IEC standard 13818-1 or ITU-T Rec. H.222.0). The transport stream standard specifies a container format encapsulating packetized elementary streams (ES), with error correction and stream synchronization features for maintaining transmission integrity when the signal is degraded.

Management console 4 is provided to configure video TS/IP server 1. In a preferred embodiment, a management console operating as a web application on the video TS/IP server is served over IP network 3. A client computer operating a web browser may interact with the management console over IP network 3 to perform management functions.

In an alternate embodiment, video TS/IP server is a PCI-based hardware card hosted in a computer. The management console in the alternate embodiment is deployed as a standalone computer software application operating within an operating system running on the computer, such as Microsoft® Windows™ or Linux. The management console interacts directly with the video TS/IP server over PCI bus 10 of the computer.

Management functions include determining the nature of the transformation of each video data stream from ingress to egress; routing each of the video data streams to a destination transport stream and ultimately to a video destination; setting the bit-rate of each video data stream; and all other functions related to the operation of the video TS/IP server. Examples of the nature of the transformation include transforming an MPEG-2 video data stream on ingress to an H.264 video data stream on egress and vice versa; transforming a raw video data stream on ingress to an MPEG-2 video data stream on egress and vice versa; and transforming a raw video data stream on ingress to an H.264 video data stream on egress and vice versa. These examples of transformations are not exhaustive but illustrative of the function of the video TS/IP server.

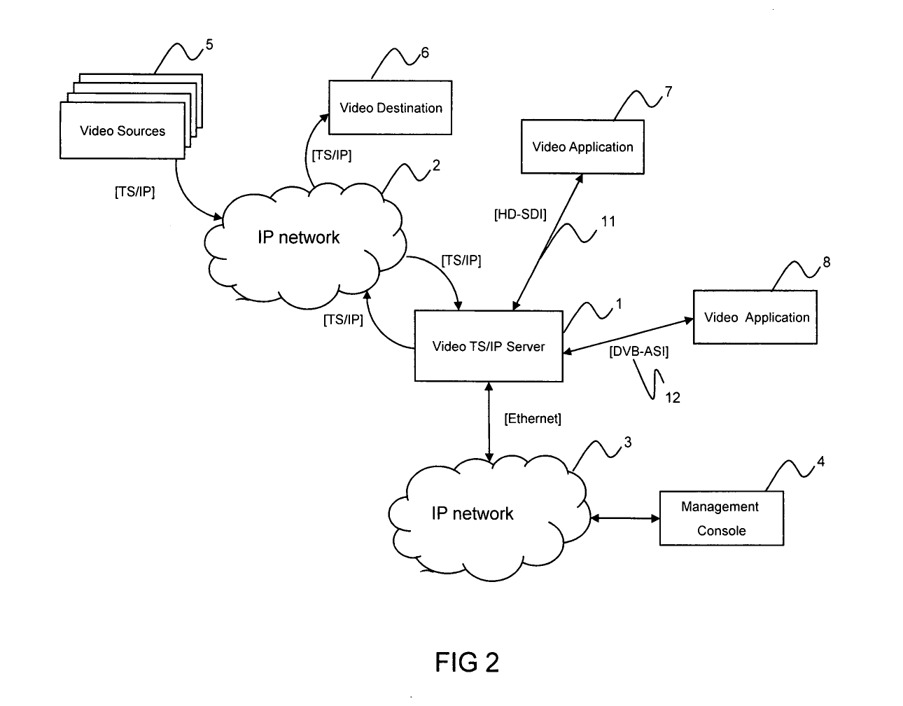

A second embodiment is in video production across an interne protocol (IP) network. In FIG. 2, video TS/IP server 1 is connected to IP network 2 and IP network 3. A set of video sources 5 and a set of video destinations 6 are connected to IP network 2. Video application 7 is connected to video TS/IP server 1 using HD-SDI connections 11 to source and sink video streams. Video application 8 is connected to video TS/IP server 1 using DVB-ASI connections 12 to source and sink video streams. Management console 4 is connected to IP network 3 and in communication with the video TS/IP server.

HD-SDI is the high-definition version of the Serial Digital Interface (SDI) specified in SMPTE-292M. This standard transmits audio and video over a single coaxial cable with a data rate of 1.485 Gbit/second and is typically used in the video production environment. DVB-ASI is the Digital Video Broadcasting Asynchronous Serial Interface which is a standard for the broadcast of digital television signals frequently used in satellite transmission, interfacility links, and telephony communications. This standard transmits audio and video data over a single coaxial cable with a data rate of 270 Mbit/second.

In operation, video data streams are encapsulated into a set of ingress transport streams by the set of video sources 5, HD-SDI video signals by video application 7, or DVB-ASI video signals by video application 8 and sent to video TS/IP server 1. The set of ingress transport streams are ingested by the video TS/IP server where they are transformed to a set of egress transport streams. An egress transport stream can be sent to one of the set of video destinations 6 over IP network 2 as a TS over IP packet stream. In one embodiment, the egress transport stream can be conditioned to be sent over a HD-SDI connection to video application 7. In another embodiment, the egress transport system can be conditioned to be sent over a DVB-ASI connection to video application 8. An egress transport stream may also be addressed to one or more video destinations in the set of video destinations. Each transport stream of the set of egress transport streams is ingested by the video destination or application to which it is addressed.

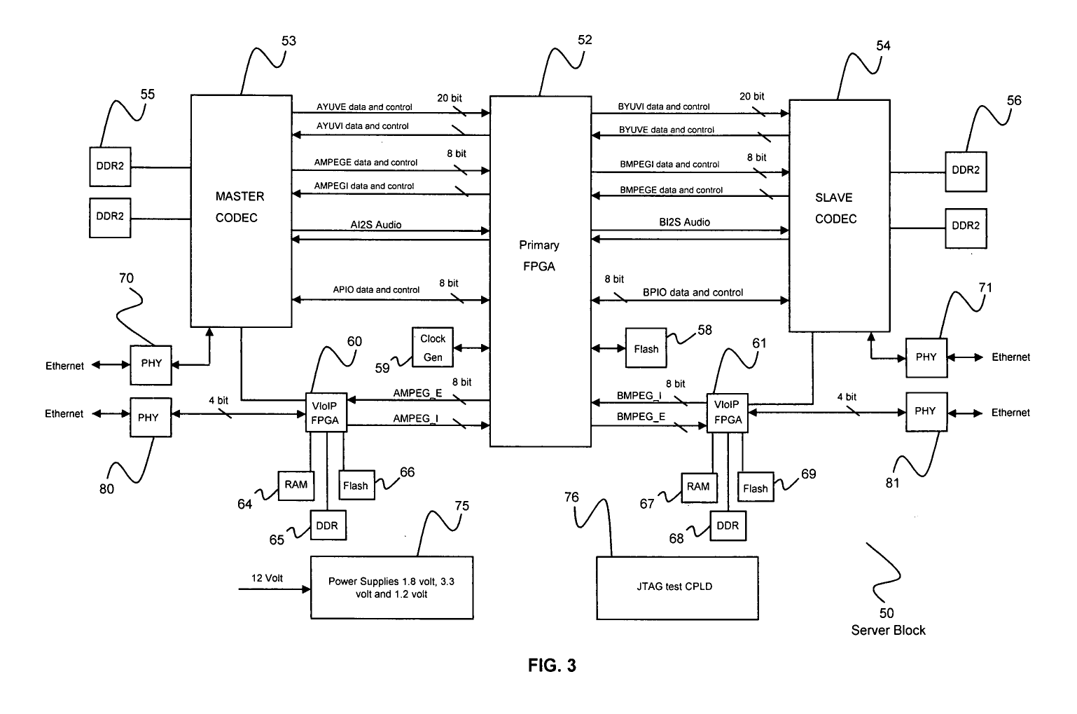

FIG. 3 is a block diagram of a preferred embodiment of a video server block 50 which comprises master codec 53, slave codec 54, primary field programmable gate array (FPGA) 52, VioIP processor 60, VioIP processor 61, and supporting components. Master codec 53 is interconnected to primary FPGA 52 via a set of data and control buses for data exchange: AYUVE data and control bus, AYUVI data and control bus car, AMPEGE data and control bus, AMPEGI data and control bus, AI2S audio data link, and APIO data and control bus. Similarly, slave codec 54 is interconnected to primary FPGA 52 via a set of data and control buses: BYUVE data and control bus, BYUVI data and control bus car, BMPEGE data and control bus, BMPEGI data and control bus, BI2S audio data link, and BPIO data and control bus. VioIP processor 60 is connected to master codec 53 for control and to primary FPGA 52 via two buses for data exchange: AMPEG_E bus and AMPEG_I bus. VioIP processor 61 is connected to slave codec 54 for control and to primary FPGA 52 via two buses for data exchange: BMPEG_E bus and BMPEG_I bus.

The supporting components connected to master codec 53 are DDR2 memory 55 and Ethernet PHY 70 (Ethernet physical layer interface device).

The supporting components connected to slave codec 53 are DDR2 memory 56 and Ethernet PHY 71 (Ethernet physical layer interface device).

The supporting components connected to the primary FPGA are clock generator 59 to provide timing for entire video server block 50, and primary flash memory 58 for holding program instructions for the primary FPGA functions and for the master and slave codecs.

The supporting components connected to VioIP processor 60 are a random access memory (RAM) 64, flash memory 66, DDR2 memory 65, and Ethernet PHY 80. VioIP processor 60 further comprises a FPGA incorporating a processor core which is configured for packetization of video transport streams over internet protocol and requires the flash memory for booting, RAM 64 and DDR2 memory 65 for operations.

The supporting components connected to second VioIP processor 61 are a random access memory (RAM) 67, flash memory 69, DDR2 memory 68, and Ethernet PHY 81. VioIP processor 61 further comprises a FPGA incorporating a processor core which is configured for packetization of video transport streams over internet protocol and requires the flash memory for booting, RAM 67 and DDR2 memory 68 for operations.

The supporting components connected to video server block 50 and appropriately interconnected to all components described so far, are power supply 75 for powering all components and JTAG test CPLD 76 for operating a test console.

The Ethernet PHY devices, Ethernet PHY 80 and Ethernet PHY 81 are further terminated with RJ45 connectors to allow for connection to an external Ethernet network. Ethernet PHY 70 and Ethernet PHY 71 can be terminated with RJ45 connectors as required by the application depending upon whether they are tied to an internal or external Ethernet device or network, respectively.

The master and slave codecs are each preferably implemented as a single chip solution on a high speed data parallel DSP type processing capability that is optimized for video signal processing. In the preferred embodiment, a multi-core processor having at least a system CPU core for handling system level processing and I/O operations and a DSP co-processor core optimized for parallel video processing. A suitable codec processor is the STORM-1 processor part SP16HP-G220 from Stream Processors Inc capable of over 400 GOPS. A suitable component for the primary FPGA is a Virtex series FPGA from Xilinks Corporation. A suitable component for VioIP processors 60 and 61 is a Cyclone series FPGA from Altera which further includes the NIOS II processor core operating a video processing application. For example, see the reference design found at http://www.altera.com/support/refdesigns/sys-sol/broadcast/ref-video.html.

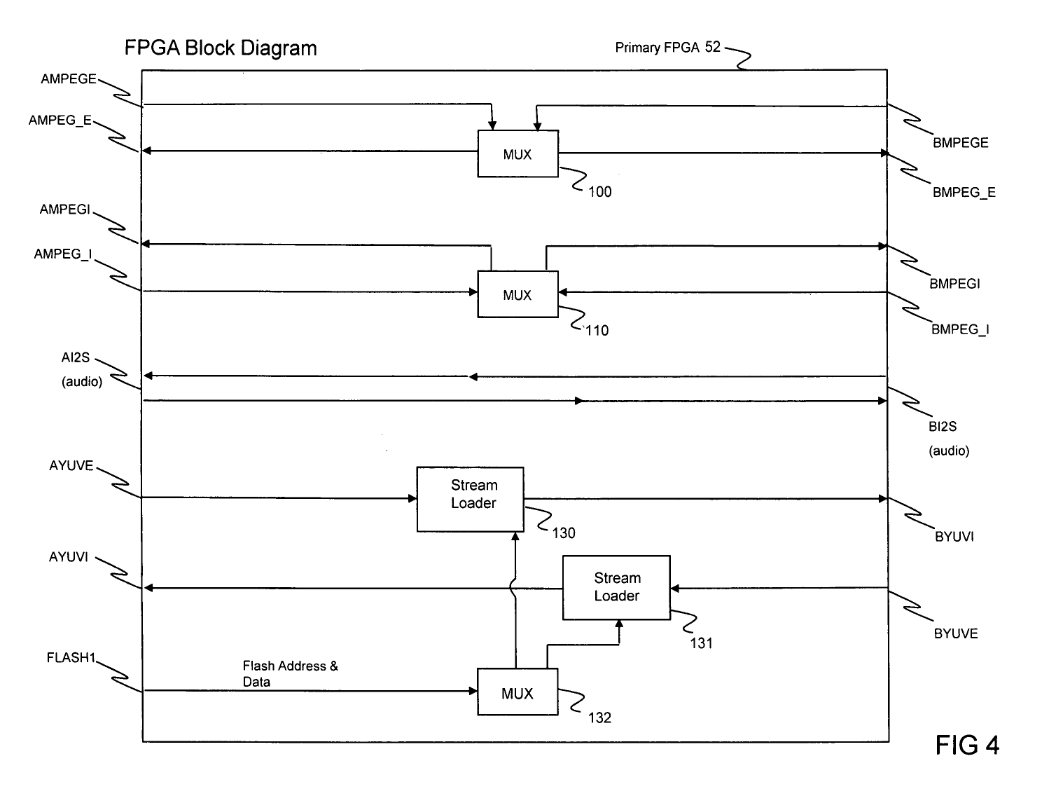

In the preferred embodiment, the primary FPGA is configured as shown in FIG. 4. The interfaces to primary FPGA 52 comprise twelve video data and control buses, two bidirectional I2S audio data links AI2S and BI2S and a parallel flash memory interface FLASH I connected to the primary flash memory. The video data and control buses configured as inputs to the primary FPGA are the AMPEGE, AMPEG_I, BMEPE, BMPEG_I, AYUVE and BYUVE buses. The video data and control buses configured as outputs to the primary FPGA are the AMPEG_E, AMPEGI, BMPEG_E, BMPEGI, AYUVI and BYUVI buses. The primary FPGA comprises parallel digital multiplexer, MUX 100; parallel digital multiplexer, MUX 110; parallel digital multiplexer, MUX 132; stream loader 130; and stream loader 131.

AMPEGE data bus and BMPEGE data bus are connected as inputs to MUX 100. AMPEG_E data bus and BMPEG_E data bus are connected as outputs of MUX 100. MUX 100 can selectively shift data from one of either the AMPEGE or BMPEGE data buses to one of either the AMPEG_E or BMPEG_E data buses. MUX 100 is further capable to simultaneously shift data from the both inputs to both outputs as selected. In the preferred embodiment, AMPEGE, AMPEG_E, BMPEGE and BMPEG_E are 8 bit data buses and MUX 100 is configured as a 16 bit×16 bit cross-connect switch.

AMPEG_I data bus and BMPEG_I data bus are connected as inputs to MUX 110. AMPEGI data bus and BMPEGI data bus are connected as outputs of MUX 110. MUX 110 can selectively shift data from one of either the AMPEG_I or BMPEG_I data buses to one of either the AMPEGI or BMPEGI data buses. MUX 110 is further capable to simultaneously shift data from the both inputs to both outputs as selected. In the preferred embodiment, AMPEGI, AMPEG_I, BMPEGI and BMPEG_I are 8 bit data buses and MUX 110 is configured as a 16 bit×16 bit cross-connect switch.

Stream loader 130 can selectively load data from FLASH1, or pass data through from the AYUVE data bus, to the BYUVI data bus. Stream loader 131 can selectively load data from FLASH1, or pass data through from the BYUVE data bus, to the AYUVI data bus. MUX 132 can selectively receive an address from either of the first or second stream loaders and send the address to the FLASH1 address bus. Correspondingly, MUX 132 can selectively transmit data appearing on the FLASH1 data bus to either the first or second stream loaders. AYUVE, BYUVE, AYUVI and BYUVI are preferably 20 bit data buses to carry raw YUV video data; FLASH1 preferably includes a 32 bit address bus and 16 bit data bus connected to the primary flash memory; the stream loaders are preferably 32 bit address and 20 bit data devices; MUX 132 preferably comprises a set of 32 (1×2) data switches for address bits and 16 (1×2) data switches for data bits.

In the preferred embodiment, the primary FPGA is configured to pass through audio data from AI2S to BI2S and vice versa.

The master and slave codecs are configured with programmed instructions stored in the FPGA flash memory and accessed via AYUVI, BYUVI and FLASH1, the programmed instructions suitable to operate video TS/IP server codec functions. Codec software will be described in more detail below.

The video server block is a flexible hardware design that can be stacked and augmented with additional hardware components to arrive at exemplary embodiments of the video TS/IP server. In PC hosted embodiment, a video TS/IP server is conceived where video server block 50 is implemented on a PC card and hosted in a PC computer utilizing a native peripheral interface. A common peripheral interface found in PC computers is the Peripheral Component Interface (PCI) and the Peripheral Component Interconnect Express (PCIe). Recent PC computer architectures support the PCIe. The processor chosen to embody the codec components of the video server block preferably includes a built-in PCI or a built-in PCIe interface bus for interfacing to a host computer system.

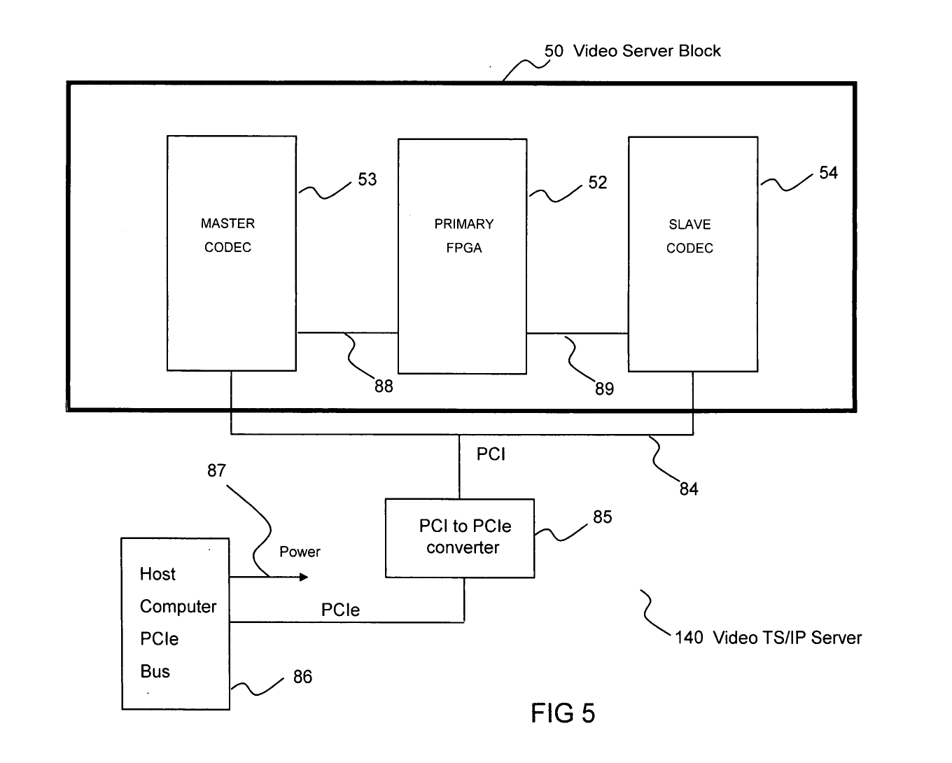

FIG. 5 shows first embodiment video TS/IP server 140 for a PC hosted video server that includes the video server block plus additional components to allow for communications with a host PC. PCI bus 84 is connected between the PCI bus ports of both master codec 53 and slave codec 54 and a PCI to PCIe bus converter IC 85. Physical PCIe bus interface 86 connects PCI/PCIe converter IC 85 to a host computer which in turn provides power 87 for video server block 50 and PCI to PCIe converter IC 85. The host computer can configure the primary FPGA 52 through PCI bus 84 via master codec 53 on APIO bus 88 or slave code 54 on BPIO bus 89.

Within a set of alternate embodiments, video TS/IP server is configured to ingress raw YUV video data streams from native video interfaces to perform encoding functions and placement into transport streams for IP transport. Within the set of alternate embodiments, the video TS/IP server is also configured to egress YUV video data streams decoded from TS over IP video streams. Within the set of alternate embodiments, the video TS/IP server is further configured as a stand-alone device, incorporating a set of video server blocks and a host processor in communication with the set of video server blocks for management and file I/O functions over Ethernet.

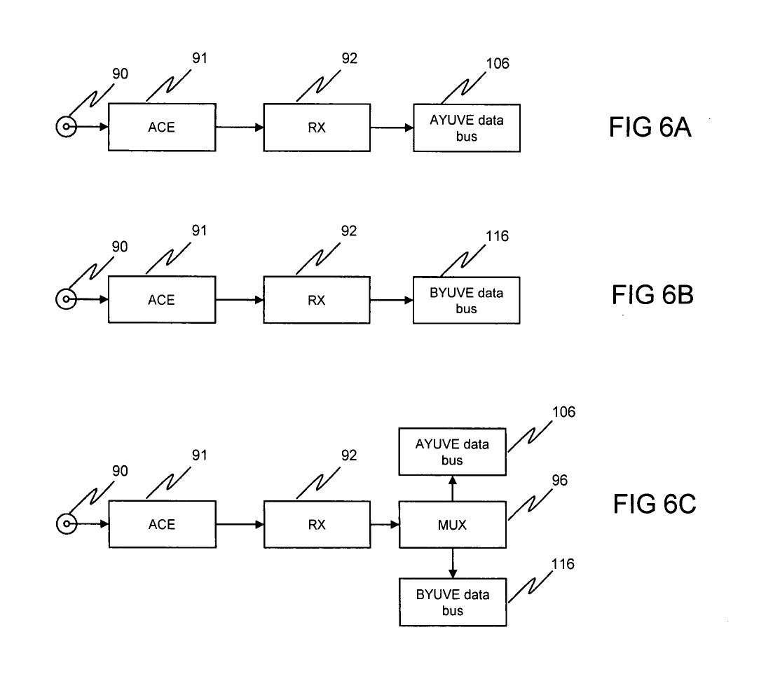

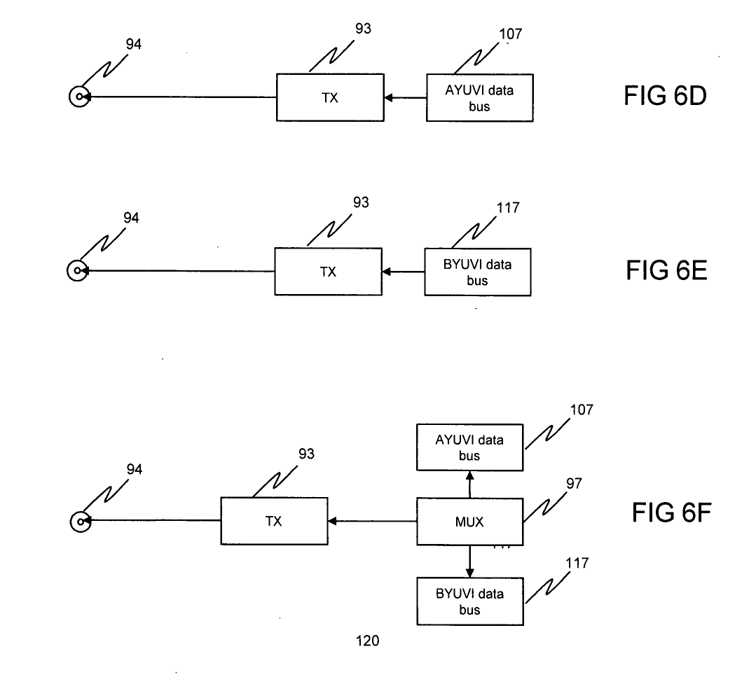

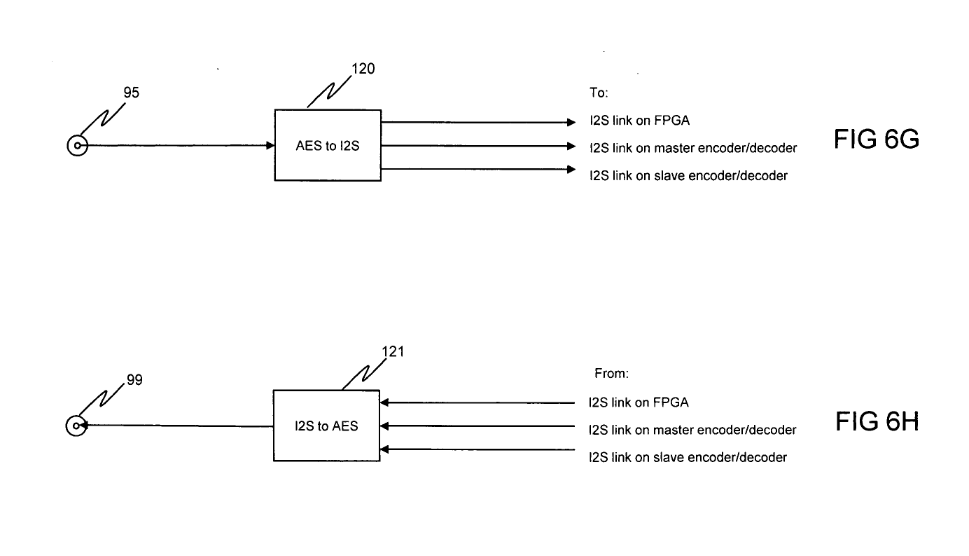

FIGS. 6A-6H each show a hardware configuration that, when connected to the video server block of FIG. 3, perform transcoding services to and from raw YUV video data streams.

In a first alternate embodiment, video server block 50 of FIG. 3 is augmented with the receive circuit of FIG. 6A by connecting SDI receiver 92 to the AYUVE data bus 106 of the video server block. Adaptive cable equalizer 91 is connected internally to SDI receiver 92 and externally to coaxial cable 90 carrying a raw YUV video signal such as the HD-SDI or DVB-ASI standard video signal format.

In a second alternate embodiment, video server block 50 of FIG. 3 is augmented with the receive circuit of FIG. 6B by connecting an SDI receiver 92 to BYUVE data bus 116 of the video server block. Adaptive cable equalizer 91 is connected internally to SDI receiver 92 and externally to coaxial cable 90 carrying a raw YUV video signal such as the HD-SDI or DVB-ASI standard video signal format.

SDI receiver 92 is preferably a multirate SDI receiver which operates in one of at least two modes selected from an SMPTE mode and a DVB-ASI mode and is capable to de-embed audio-signals. In SMPTE mode, the SDI receiver can perform full SMPTE processing of an HD-SDI serial digital data stream. In DVB-ASI mode, 8b/10b decoding is applied to a received serial digital data stream.

Adaptive cable equalizer 91 is preferably a high-speed integrated circuit designed to equalize and restore signals received over 75Ω coaxial cable optimized for performance at 1.485 Gb/s and 2.97 Gb/s, and further designed to compensate for the DC content of SMPTE pathological test patterns.

A suitable device for SDI receiver 92 is part number GS2970 from Gennum Corporation. A suitable device for adaptive cable equalizer 91 is part number GS2974 also from Gennum Corporation.

In a third alternate embodiment, video server block 50 of FIG. 3 is augmented with the receive circuit of FIG. 6C by connecting SDI receiver 92 to digital multiplexer 96. The digital multiplexer is further connected to AYUVE data bus 106 and BYUVE data bus 116 of the video server block. Adaptive cable equalizer 91 is connected internally to SDI receiver 92 and externally to coaxial cable 90 carrying a raw YUV video signal such as the HD-SDI or DVB-ASI standard video signal format. Digital multiplexer 96 can be selectively configured to switch digital data streams from SDI receiver 92 to either AYUVE data bus 106 or BYUVE data base 116.

In a fourth alternate embodiment, video server block 50 of FIG. 3 is augmented with the transmit circuit of FIG. 6D wherein SDI transmitter 93 is connected to AYUVI data bus 107 of the video server block. SDI transmitter 93 is also connected externally to a coaxial cable 94.

In a fifth alternate embodiment, video server block 50 of FIG. 3 is augmented with the transmit circuit of FIG. 6E wherein SDI transmitter 93 is connected to BYUVI data bus 117 of the video server block. SDI transmitter 93 is also connected externally to 75-ohm coaxial cable 94.

SDI transmitter 93 is capable to generate at least a SMPTE 292M or DVB-ASI compliant serial digital output signal. In SMPTE mode, the SDI transmitter can perform all SMPTE processing features. In DVB-ASI mode, the SDI transmitter will perform 8b/10b encoding prior to transmission on the 75-ohm coaxial cable. A suitable device for SDI transmitter 93 is part number GS2972 from Gennum Corporation.

In a sixth alternate embodiment, video server block 50 of FIG. 3 is augmented with the transmit circuit of FIG. 6F wherein SDI transmitter 93 is connected to digital multiplexer 97. The digital multiplexer is further connected to AYUVI data bus 107 and BYUVI data bus 117 of the video server block. SDI transmitter 93 is also connected externally to a coaxial cable 94. Digital multiplexer 96 can be selectively configured to switch digital data streams from either AYUVI data bus 107 or BYUVI data bus 117 to SDI transmitter 93.

In a seventh alternate embodiment, video server block 50 of FIG. 3 is augmented with the audio receiver circuit of FIG. 6G wherein audio signal converter 120 is connected internally to one or more of three I2S links selected from an I2S link to the primary FPGA, an I2S link to the master codec and an I2S link to the slave codec. Audio signal converter 120 is externally connected to an audio source device over suitable cable 95. Audio signal converter 120 is preferably programmed to convert a standard digital audio signal to an I2S digital signal format.

In an eighth alternate embodiment, video server block 50 of FIG. 3 is augmented with the audio transmitter circuit of FIG. 6H wherein an audio signal converter 121 is internally connected to one or more of three I2S links selected from an I2S link to the primary FPGA, an I2S link to the master codec and an I2S link to the slave codec. Audio signal converter 121 is externally connected to an audio receiver device over a suitable cable 99. Audio signal converter 121 is preferably programmed to convert an I2S digital signal format to a standard digital audio signal.

In the seventh and eighth embodiments, the audio signal converter can be a device suitable to convert any of the standard digital audio signal formats to and from I2S. Examples of standard digital audio formats for carrying raw audio data streams is the balanced AES/EBU, unbalanced AES/EBU and S/PDIF.

The alternate embodiments of FIGS. 6A-6H can be combined to create further embodiments of the video TS/IP server. For example, the video server block of FIG. 3 can be combined with the third alternate embodiment of FIG. 6C and the sixth alternate embodiment of FIG. 6F to form a QikStak block having four independent Ethernet ports, an HD-SDI receive port and an HD-SDI transmit port.

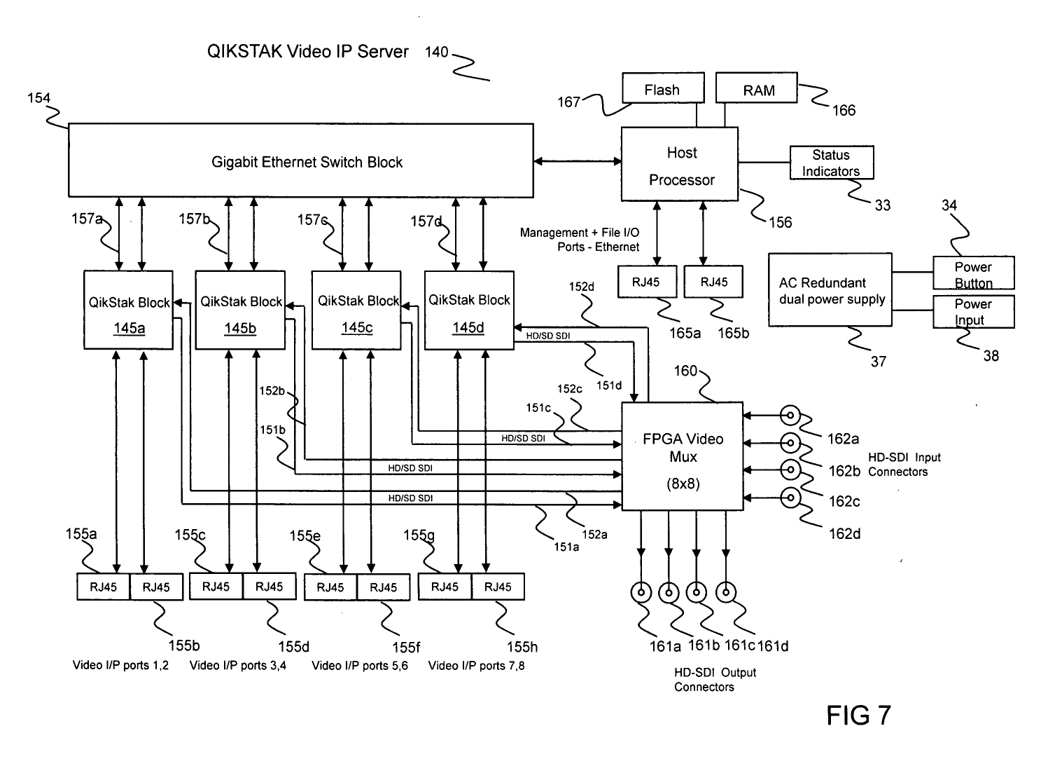

FIG. 7 shows a stand-alone embodiment of video TS/IP server 150 comprising a set of QikStak blocks including QikStak block 145a, QuiStak block 145b, QikStak block 145c and QikStak block 145d. Video TS/IP server 150 further comprises a host processor 156, FPGA video multiplexer 160, Ethernet switch block 154, and dual redundant hot swappable power supply 37.

Host processer 156 is connected to flash memory 167, random access memory RAM 166 and a set of status indicators 33. Host processor block 156 is further connected to Ethernet switch block 154 and to FPGA video multiplexer 160. A pair of host Ethernet management ports 165a and 165b operated by the host processor is connected to a pair of physical RJ-45 ports, one port for file I/O, the other port for operational management of the video TS/IP server. The host processor is configured with programmed instructions stored in the flash memory and suitable to operate the video TS/IP server. Host processor software will be described in more detail below.

The dual redundant hot swappable power supply incorporates a power input connector 38 normally connected to AC power such as 110 V and a power button 34 for connecting and disconnecting power to the other components of the video TS/IP server.

QikStak block 145a has a pair of Ethernet interfaces 157a connected to Ethernet switch block 154 for management and file I/O, Ethernet interfaces 155a and 155b for sending and receiving video TS over IP, HD-SDI transmit port 151a and HD-SDI receive port 152a. QikStak block 145b has a pair of Ethernet interfaces 157b connected to Ethernet switch block 154 for management and file I/O, Ethernet interfaces 155c and 155d for sending and receiving video TS over IP, HD-SDI transmit port 151b and HD-SDI receive port 152b. QikStak block 145c has a pair of Ethernet interfaces 157c connected to Ethernet switch block 154 for management and file I/O, Ethernet interfaces 155e and 155f for sending and receiving video TS over IP, HD-SDI transmit port 151c and HD-SDI receive port 152c. QikStak block 145c has a pair of Ethernet interfaces 157d also connected to Ethernet switch block 154 for management and file I/O, Ethernet interfaces 155g and 155h for sending and receiving video TS over IP, HD-SDI transmit port 151d and HD-SDI receive port 152d. Ethernet interfaces 155a, 155b, . . . 155h are connected to a set of physical RJ-45 ports for connection to an external IP network. HD-SDI receive ports 151a-151d and HD-SDI transmit ports 152a-152d are connected to FPGA video multiplexer 160.

FPGA video multiplexer 160 has a set of input HD-SDI ports 162a-162d and a set of output HD-SDI ports 161a-161b connected to a set of coaxial cable connectors. The FPGA video multiplexer can be configured to switch any one port of the set of HD-SDI input ports to any one of HD-SDI receive ports 152a-152d. The FPGA video multiplexer can be further configured to dynamically switch any one of HD-SDI transmit ports 151a-151d to any one port of the set of HD-SDI output ports. In another alternate embodiment, raw YUV video data may be input or output over DVB-ASI I/O ports, instead of or in combination with HD-SDI input and output ports, the DVB-ASI I/O ports connected to the FPGA video multiplexer.

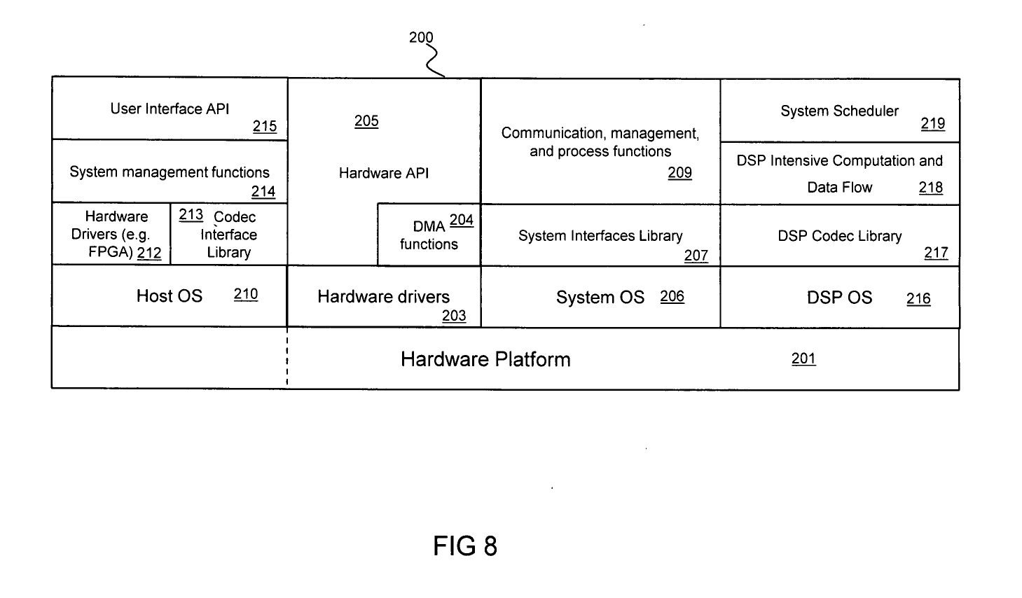

The software framework and programmable aspects of the present invention are explained with reference to FIGS. 8, 9 and 10. The Video TS/IP software system is described by software framework 200 of FIG. 8, which operates on hardware platform 201 having functional components consistent with the preferred and alternate hardware embodiments of the video server block and video TS/IP server. Software framework 200 is realized in the embodiments described herein.

Software framework 200 executes under three operating systems, host OS 210, codec system OS 206 and codec DSP OS 216. The host OS operates on a host processor interacting with one or more video server blocks. The codec system OS and codec DSP OS operate on the master and slave codecs. In the preferred embodiment, the codec system OS is an embedded Linux operating system and the DSP OS is RTOS. If the host system is a PC as in the PC hosted embodiment, the host OS can be Microsoft® Windows™. If the host system is embedded as in the stand-alone embodiment a Linux operating system is preferred. Under these operating systems, software framework 200 comprises a set of modules that permit rapid adaptation to changing standards as well as customization to users' specific needs and requirements with a short development cycle.

Codec system OS 206 interfaces to a set of hardware drivers 203 and a set of hardware control APIs 205. A particularly important set of hardware drivers and hardware API for moving video and audio data into and out of the codec is direct memory access (DMA) functions 204. Codec system OS 206 utilizes system interfaces library 207 along with the communications and peripheral functions module 209 to handle the system work load. System interfaces library 207 contains library interfaces for functions such as video device drivers and audio device drivers while communications and peripheral functions module 209 contains functions such as device drivers for PCI bus and Ethernet interfaces, and panel control functions if required. Codec system OS 206 also handles the system function of servicing the host processor over the PCI bus or Ethernet interfaces in a hosted environment.

Codec DSP OS 216 handles the execution of DSP centric tasks and comprises DSP codec library 217, DSP intensive computation and data flow 218, and system scheduler 219. Examples of DSP centric tasks include codec algorithmic functions including encoding and decoding and video data streaming functions. System scheduler 219 manages thread and process execution between the codec system OS and the codec DSP OS.

The operating systems, libraries, drivers, functions and APIs of a codec are stored in persistent storage media attached to the codec. Persistent storage media is preferably flash memory, but can include hard drives, CD drives, USB flash devices and other forms of static memory. The operating systems, libraries, drivers, functions and APIs of the codec access RAM memory such as DDR memory attached to the codec and utilize the CPU and DSP cores of the codec to perform operations essential to the video TS/IP server.

Host OS 210 includes a set of hardware drivers 212 for communicating with the various components of a video server block including at least the primary FPGA, the master codec and the slave codec. Codec interface library 213 provides support for higher level system management functions 214 related to more complex codec specific configurations, for example, choosing the encoder and decoder compression algorithms. User interface API 215 is provided. Preferably, user interface API 215 includes a web hosting application for configuration, suitable for access over an IP network using a web browser. User interface API 215 may also include standard TCP/IP protocol functions such as a file transfer protocol (FTP) application suitable for moving files into and out of the host, and for updating the software in the host and on the codecs.

The host OS, libraries, drivers, functions and APIs of the host are stored in persistent storage media attached to the host. Persistent storage media include flash memory, hard drives, CD drives, USB flash devices. The host OS, libraries, drivers, functions and APIs of the host access RAM memory within the host and utilize the CPU of the host to perform operations essential to the video TS/IP server.

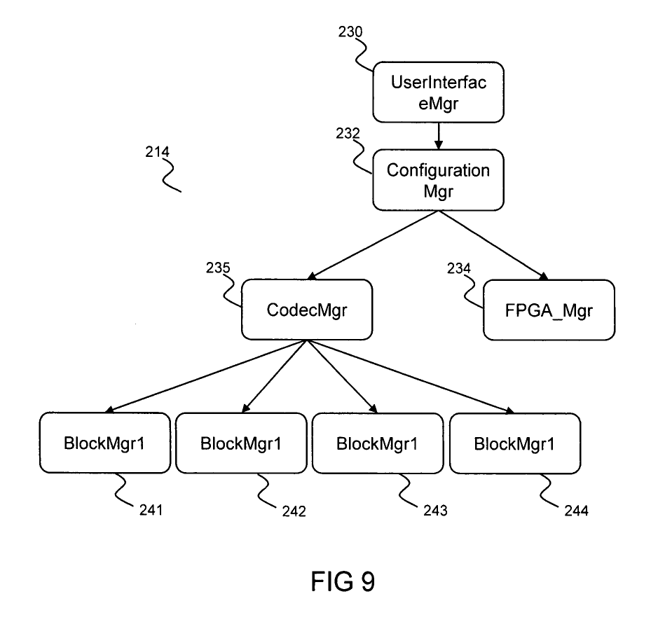

User interface API 215 and system management functions 214 are further described with the help of FIG. 9. The user interface API includes UserInterfaceMgr 230 which manages data flowing to and from a user, such as communicating available configuration operations, validating user input, providing user authentication services, and serving web-pages. The system management functions include ConfigurationMgr 232, CodecMgr 235, FPGA_Mgr 234 and a set of video server block managers: BlockMgr 241, BlockMgr 242, BlockMgr 243 and BlockMgr 244. ConfigurationMgr 232 communicates/accepts configuration settings to/from UserInterfaceMgr 230 to define encoding and decoding tasks on selected video streams and is responsible to provision all hardware components to the defined tasks. ConfigurationMgr 232 comprises FPGA_Mgr 234 and CodecMgr 235. FPGA_Mgr 234 utilizes an FPGA device driver included in the host hardware drivers to read and write FPGA registers to perform tasks such as configuring the primary FPGA muxes and handling hardware interrupts from all FPGA components. CodecMgr 235 manages video server blocks and the common functions of the video server blocks such as software upgrades and overall system health. CodecMgr 235 comprises the video server block managers, BlockMgrs 241, 242, 243 and 244, each of which send configuration data to the master and slave codecs of their corresponding video server blocks. The video server block managers also control and monitor the status of their corresponding video server blocks, for example, enabling codec operations and reporting when an encoding/decoding job is complete.

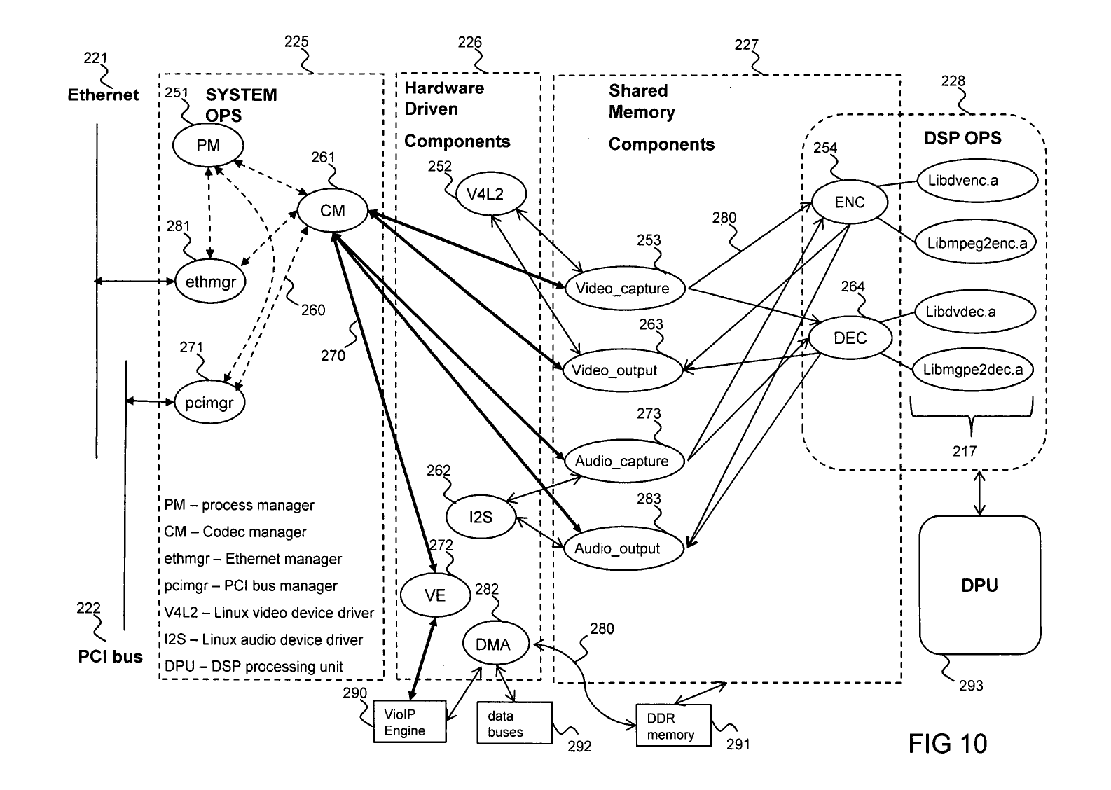

The codec portion of software framework 200 is organized into a set of modular components operating as a codec system. FIG. 10 is a block diagram showing the components of the codec system. Components represent functional areas that map to subsystems of processes and device drivers: each component having an associated set of responsibilities and behaviors as well as support for inter-component communication and synchronization. Components do not necessarily map directly to a single process or single thread of execution. Sets of processes running on the codec typically implement responsibilities of a component within the context of the appropriate OS. The principal components of the codec software system are system OS components 225, hardware driven components 226, shared memory components 227 and DSP OS components 228. In FIG. 10, interprocess communications are designated by dashed lines between components, control paths are designated by bold lines between components and data paths are designated by thin lines between components.

Within system OS components 225 are process manager 251, codec manager 261, PCI manager 271 and Ethernet manager 281. Process manager 251 controls all the states and processes of the codec including the codec manager, the PCI manager, and the Ethernet manager via communications links 260 shown in dashed lines. Ethernet manager 281 controls all communications between the codec and Ethernet network 221. PCI manager 271 controls all communications including PCI interrupt generation and handling between the codec and host PCI bus 222.

Within hardware driven components 226 are a video device driver, V4L2 252, audio device driver, I2S 262, VioIP driver 272 and DMA controller 282. V4L2 252 is implemented as the standard Linux V4L2 video driver and I2S 262 is implemented as the standard Linux I2S audio driver. The video device driver manages video data input and output requirements of the codec as required by configuration, operating on video output buffers to create egress video elementary streams and operating on ingress video streams to store video elementary streams in video input buffers. Similarly, the audio device driver manages audio data input and output to and from audio data buffers. The video and audio device drivers utilize DMA controller 282 to move data to and from external data buses 292 and DDR memory 291. Process manager 251 utilizes VioIP driver 272 to control external VioIP engine 290 attached to the codec.

101051 Shared memory components 227 manage data held within DDR memory 291. Shared memory components 227 include the methods: video_capture 253, video_output 263, audio_capture 273, audio_output 283, ENC 254 and DEC 264. The video_capture and video_output methods operate on video stream data including metadata contained in suitable data buffers existing within the DDR memory. The audio_capture and audio_output methods operate on audio stream data including metadata contained in suitable data buffers existing within the DDR memory. Video_capture, video_output, audio_capture and audio_output methods can be accessed by the system OS components and the DSP OS components, and these methods can access the hardware driven components. For example, the video_output object method can utilize the V4L2 video device driver along with the DMA controller to stream video data to a data bus, such as the AMPEG_E, from a video buffer in the DDR memory. Codec manager 261 controls video-capture 253, video_output 263, audio_capture 273, audio_output 283 and ENC 254. Data flows between V4L2 252 and video_capture 253 and between V4L2 252 and video_output 263. Data also flows between I2S 262 and audio_capture 273 and between I2S 262 and audio_output 283.

DSP OS components comprise the ENC 254 and DEC 264 and further comprise DSP codec library 217 of encoder and decoder algorithms optimized for DSP processing unit, DPU 293.

ENC 254 encapsulates a set of video and audio processing methods for encoding a first data buffer containing raw YUV video and audio data into a second data buffer containing MPEG2 and H.264 video data. ENC 254 can utilize the configurable compression algorithms in the DSP codec library. DEC 264 encapsulates a set of video and audio processing methods for decoding a third data buffer containing MPEG2 and H.264 video data streams video data streams into a fourth data buffer containing raw YUV video and audio data streams. DEC 264 can utilize the configurable compression algorithms in the DSP codec library. First, second, third and fourth data buffers can be accessed by the video_capture, video_output, audio_capture and audio_output methods.

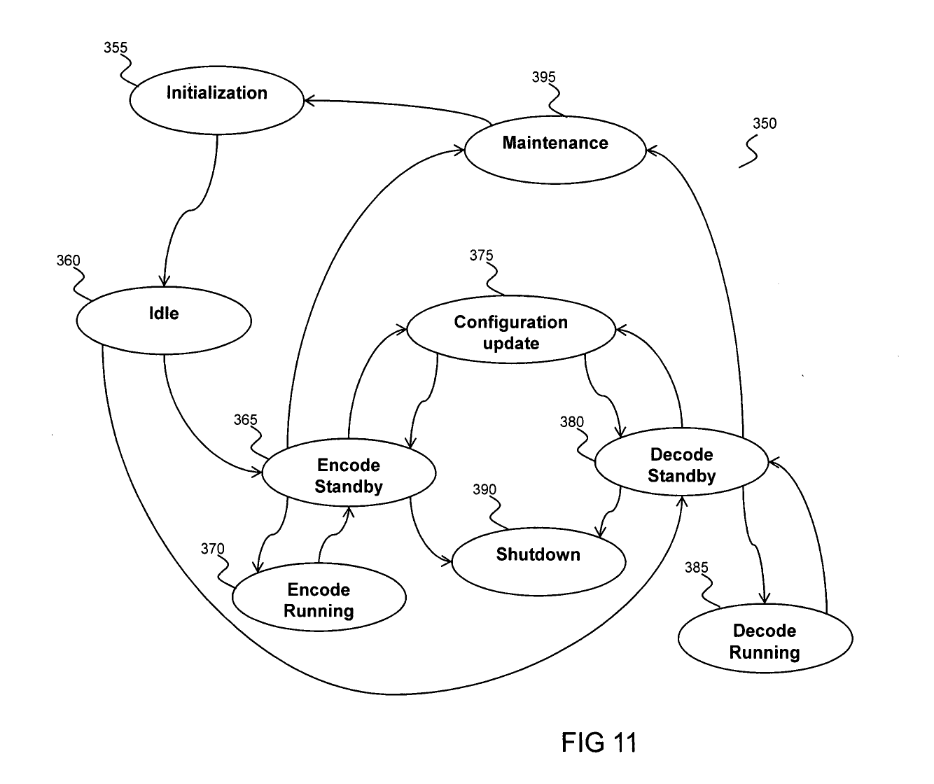

In operation, the codec system follows a sequence of operational states according to state diagram 350 of FIG. 11. Interactions with codec system to program the configuration and to change the operational mode causes the codec system to transition between the different operational states as shown.

The codec system starts from initialization state 355 while booting and does not require a host system interaction. However, the codec system may be put into this state by sending a message from the host system to the process manager. During the initialization state the codec system boots, loading program instructions and operational data from flash memory. Once initialization is complete, the codec system transitions automatically to idle state 360, wherein the codec system is operational and ready for host communication. The process manager keeps the codec system in idle state 360 until a “start encode” or “start decode” command is received from the PCI or Ethernet manager. From idle state 360, the codec system may transition to either encode standby state 365 or decode standby state 380 depending upon the operational mode of the codec system being configured to encode or decode, respectively, according to the current configuration.

Upon entering encode standby state 365, the codec system loads an encoder algorithm and is ready to begin encoding immediately upon receiving a “start encode” command from the host system via the PCI or Ethernet manager. When the “start encode” command is received by the codec manager, the codec system transitions from encode standby state 365 to encode running state 370. Encode standby state 365 may also transition to configuration update state 375 or to shutdown state 390 upon a configuration change request or a shutdown request from the host system, respectively. One other possible transition from encode standby state 365 is to maintenance state 395.

Encode running state 370 is a state in which the codec system, specifically the DSP OS and DPU, is actively encoding video and audio data. The only allowed transition from encode running state 370 is to encode standby state 365.

When entering decode standby state 380, the codec system loads a decoder algorithm and is ready to begin decoding immediately upon receiving a “start decode” command from the host system via the PCI or Ethernet manager. When the “start decode” command is received by the codec manager, the codec system transitions from decode standby state 380 to decode running state 385. Decode standby state 380 may also transition to configuration update state 375 or to shutdown state 390 upon a configuration change request or a shutdown request, respectively, from the host system. One other possible transition from decode standby state 380 is to maintenance state 395.

Decode running state 385 is a state in which the codec system, specifically the DSP OS and DPU, is actively decoding video and audio data. The only allowed transition from decode running state 385 is to decode standby state 380.

In configuration update state 375, a new configuration set is selected to be the current configuration or the current configuration is altered via the PCI or Ethernet manager. The only allowed transitions from the configuration update is to encode standby state 365 or decode standby state 380, depending upon the configuration setting.

Transitions to maintenance state 395 only arrive from encode standby state 365 or decode standby state 380 when a major codec system issue fix or a software update is required. The software update process is managed by the PCI or Ethernet manager. The only possible transition from maintenance state 395 is to initialization state 355.

Transitions to shutdown arrive from encode state 365 or decode standby state 380 upon a power down request from PCI or Ethernet manager, wherein the codec system promptly powers down.

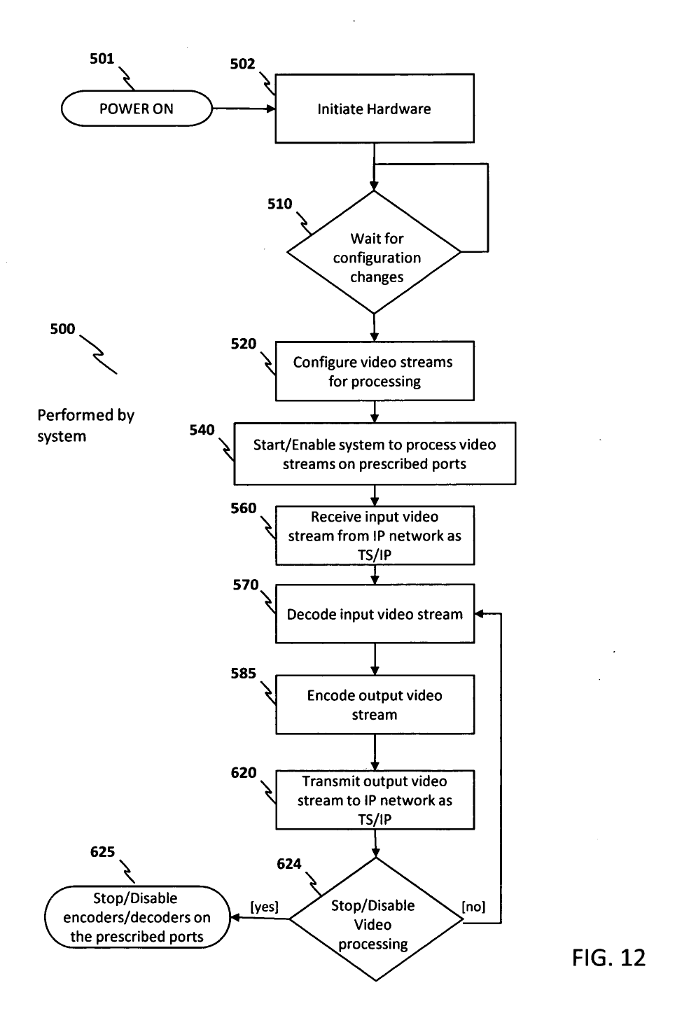

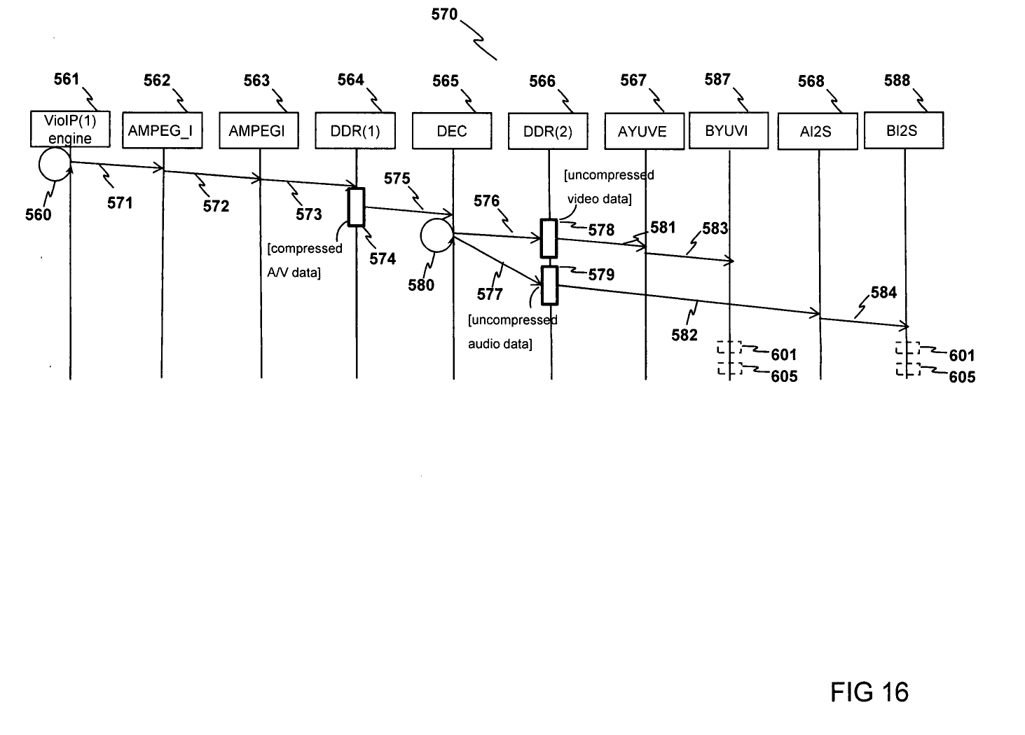

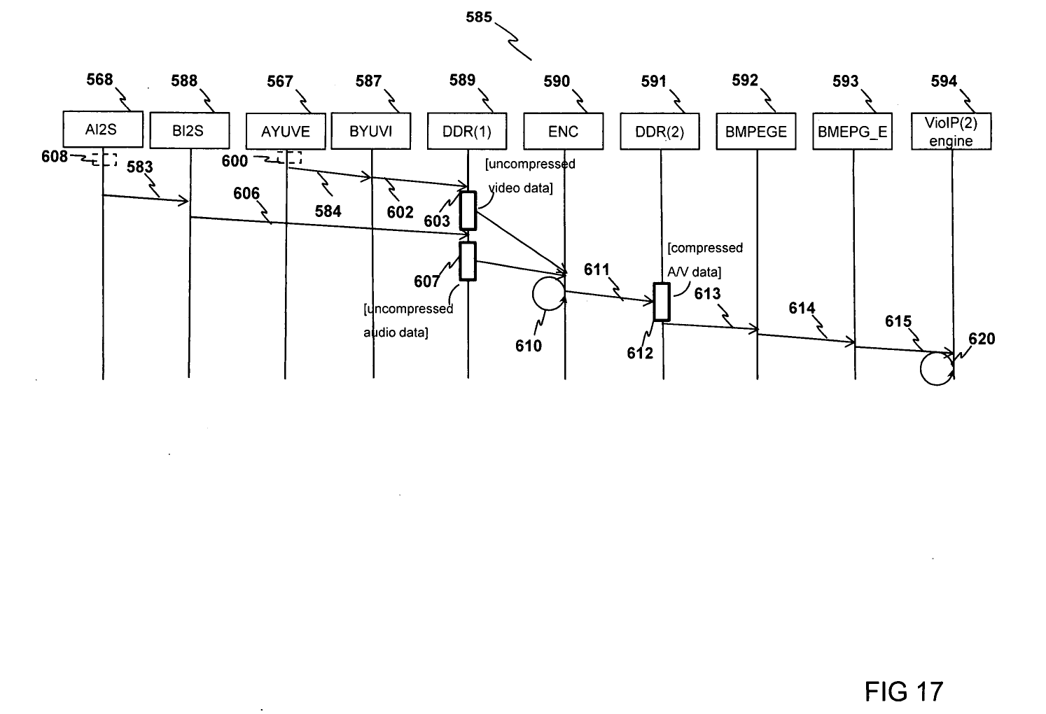

Referring to flow charts in FIGS. 12-15 and sequence charts in FIGS. 16 and 17, the operations of the video TS/IP server are further explained. Beginning with step 501 of FIG. 12, the video TS/IP server is powered on and power is supplied to individual video server blocks and supporting components accordingly. In step 502, the hardware components are initialized and when initialization completes, the video TS/IP server waits for configuration changes to be made. When such a change is made by a host subsystem of the video TS/IP server, then a set of video streams on a set of prescribed ports are configured for processing in step 520. Once configured, the video server blocks are enabled to process the set of video streams in step 540. At step 560, an input video stream is received as a transport stream over IP from the IP network connected to the video TS/IP server. At step 570, the input video stream is decoded by a video server block. At step 585, an output video stream is encoded and at step 620, the output video stream is transmitted to the IP network as a transport stream over IP. The video TS/IP server monitors the host subsystem for a command to selectively stop or disable video processing for the input or output video stream in step 624. If a command to stop video processing is received then at step 625, video processing is stopped for the input or output video stream selected. Video streams not selected in step 624 continue to be processed as in steps 560 through 620.

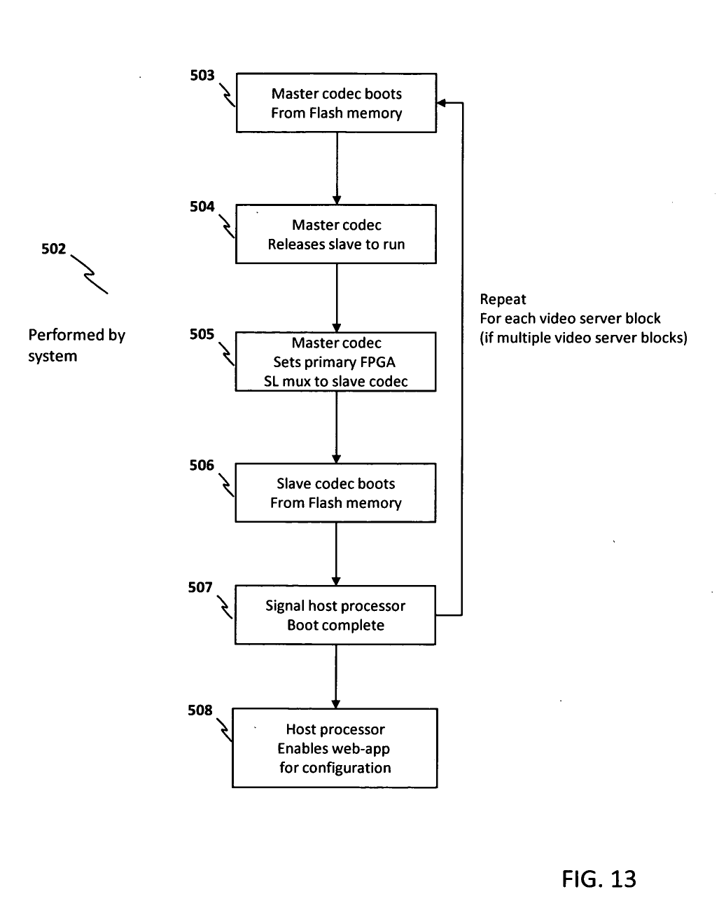

FIG. 13 describes the initialization process, step 502, which begins when the designated master codec boots its operating system from flash memory in step 503 and executes its process manager. In the preferred embodiment, the primary FPGA powers up with the appropriate stream loader and flash memory mux configured to stream data from flash memory through the primary FPGA, to the master codec via the AYUVI data bus. At step 504, the master codec releases the slave codec to operate. At step 505, the master codec sets the primary FPGA registers so that the slave stream loader and mux are configured to stream data from flash memory through the primary FPGA to the slave codec via the BYUVI data bus. Then, at step 506, the slave codec boots its operating system and executes its process manager. At step 507, the master and slave codecs signal the host subsystem that the boot process is complete. At step 508, the host subsystem enables a web application for video TS/IP server configuration.

In a preferred embodiment, the master and slave codecs become independent devices after the boot process completes, independently receiving and transmitting data to/from management interfaces and processing video to/from video I/O ports. In TS/IP only configurations, video decoded by one codec is encoded by the other codec, the video stream being transmitted from one codec to the other via the AYUVE, AYUVI, BYUVE and BYUVI data buses.

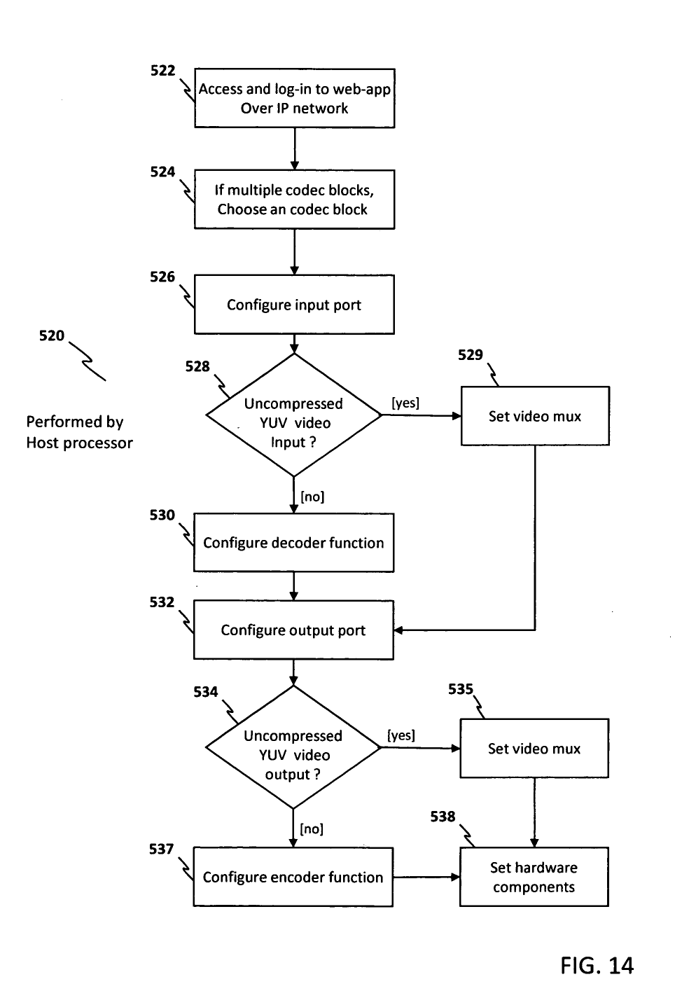

FIG. 14 describes the configuration process of step 520 which is performed by the host processor. Once the web application for video TS/IP server configuration is up and running, a user may log in to the web application via an IP network using a suitable web browser deployed on a user's computer. The web application may request authentication information and proceed through an authentication process to allow configuration of the video TS/IP server. At step 524, if there are a multiple video server blocks in the video TS/IP server, a video server block is chosen for configuration. A default video server block may be preconfigured. At step 526, an input port is defined from which a video stream is to be captured. Selections include one of two Ethernet ports or a raw YUV video input port, such as an HD-SDI input port. If at step 528, a raw YUV video input port is selected then step 529 is executed, otherwise step 530 is executed. At step 529, if a video multiplexer is available to select from multiple HD-SDI input ports, then a selection defining the HD-SDI input port is made.

At step 530, the decoder function is configured. Possible decoder configurations in the preferred embodiment include transport stream formats: MPEG2, H.264, DV25 and DVC-pro/25/50/100. Video resolution, compression level and bit rate are inherent to the ingress transport stream and therefore autodetected.

At step 532, the output port is defined for the egress video data stream as either a TS/IP assigned to an Ethernet port or as a raw YUV video output. At step 534, if raw YUV video output is defined then step 535 is executed, otherwise step 537 is executed. At step 534, if a video multiplexer is available to select from multiple output HD-SDI output ports, then a selection defining the HD-SDI output port is made.

At step 537, the encoder function is configured. Possible encoder configurations in the preferred embodiment include transport stream formats: MPEG2, H.264, DV25 and DVC-pro/25/50/100. Video resolution, compression level and bit rate are also selected as a part of the encoder configuration. Selecting a transport stream format for the encoder function that is different from the decoder function results in an overall transcoding process. Selecting a compression level or a bit-rate for the encoder function that is different from the compression level or bit-rate for the decoder function results in an overall transrating process.

In step 538, the hardware components are set on the selected video server block to match the configuration. Each codec configures itself appropriately as an encoder or decoder and the host processor configures the primary FPGA to accomplish the correct data flow, for example, enabling a multiplexer to connect the AMPEG_I data bus to the AMPEGI data bus.

Note that the steps 530 and 537 illustrate a transrating capability for the video TS/IP server in addition to a transcoding capability. In transrating operations, the output video stream bit-rate can be configured to be different than the input video stream bit-rate. Transrating typically involves selecting a different compression algorithm for the output video stream than what is used for the input video stream. In transcoding operations, the output video stream resolution or format is different from the input video stream resolution or format. For example, capturing an MPEG2 video stream and sending out an H.264 video stream is a transrating operation.

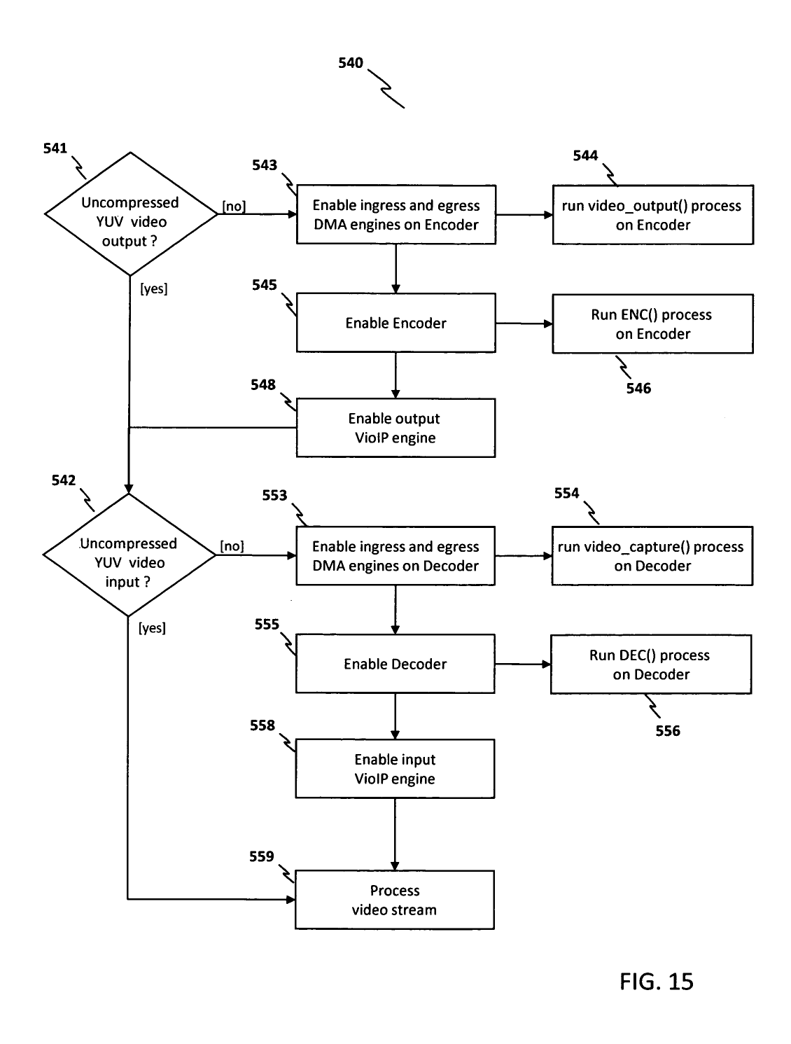

FIG. 15 describes step 540 to enable video processing of a video stream by a video server block. Step 541 determines if an encoder function is required. In step 541, if raw YUV video was selected for output, then step 542 is performed, otherwise an encoder function is required and step 543 is performed wherein the DMA controller of a first codec is enabled to stream ingress and egress of video and audio data to/from ingress and egress data buffers, respectively. At step 544, the codec manager of the first codec executes a command to the video_output method to write video data to the egress data buffer. At step 545, the codec manager of the first codec executes a command to the ENC method to load and run an encoder process on the ingress video data buffer. At step 546, the encoder process operates on data in the ingress data buffer and stores the result in the egress data buffer. At step 548, the codec manager configures a first VioIP engine to process the audio/video (A/V) data from the first codec as transport streams suitable for IP transport.

The method continues at step 542, where if raw YUV video was selected for input, then step 559 is performed, otherwise a decoder function is required and step 553 is performed wherein the DMA controller of a second codec is enabled to stream ingress and egress of video and audio data to/from ingress and egress data buffers, respectively. At step 554, the codec manager of the second codec executes a command to the video_capture method to read video data from the ingress data buffer. At step 555, the codec manager of the second codec executes a command to the DEC method to load and run a decoder process on the ingress data buffer. At step 556, the decoder process operates on data in the ingress data buffer and stores the result in the egress data buffer. At step 558, the codec manager configures a second VioIP engine to process transport streams received over Ethernet from the IP network to audio/video (A/V) data for decoding by the second codec.

In step 559, video streams are captured from input ports (Ethernet or HD-SDI) and output via output ports (Ethernet or HD-SDI) according to the configurations. The sequence diagrams of FIGS. 16-19 further explain the processing sequence that occurs in step 559.

Beginning with FIG. 16, a decode sequence corresponding to decode step 570 is shown involving the hardware components: VioIP engine 561, AMPEG_I data bus 562, AMPEGI data bus 563, first DDR memory 564, a codec configured and operating as decoder DEC 565, second DDR memory 566, AYUVE data bus 567, BYUVI data bus 587, AI2S data link 568 and BI2S data link 588. Time progresses downward in the drawing. Decode step 570 begins just after step 560 when a compressed A/V data stream is received as an IP packet stream from an IP network connected to an Ethernet port of the video TS/IP server. VioIP engine 561 deserializes the IP packet stream and separates out the transport stream which appears in step 571 on AMPEG_I data bus 562. Data on the AMPEG_I data bus appears on the AMPEGI data bus in step 572 as configured in the primary FPGA. In step 573, the DMA engine of the codec streams data from the AMPEGI data bus into data buffer 574. In step 575, decoder DEC 565 extracts video and audio data from data buffer 574 and in step 580 decodes the video and audio data into an uncompressed YUV video data stream and an uncompressed audio data stream. At step 576, the uncompressed YUV video data stream is stored in data buffer 578. At step 577, the uncompressed audio data stream is stored in data buffer 579. At step 581, the data buffer 578 is transmitted by the DMA engine to AYUVE data bus 567. At step 582, the data buffer 579 is moved by the DMA engine to AI2S data link 568. At step 583, uncompressed video data appearing on AYUVE data bus is forwarded to the BYUVI bus and at step 584, uncompressed audio data appearing on AI2S data link is forwarded to the BI2S data link. At step 601, the uncompressed video and audio data can be captured by a second codec for encoding. If the video server block is configured for uncompressed YUV video output, the uncompressed video and audio data is transferred from the BYUVI bus and BI2S data link to an SDI transmitter at step 605. The SDI transmitter can be configured to transmit according to the HD-SDI or the DVB-ASI standard.

A video server block can be optionally configured so that the uncompressed video and audio data is encoded and transmitted out as TS/IP to an IP network and simultaneously transmitted out over HD-SDI. This option allows for monitoring of an A/V transport streams as it passes through the video TS/IP server.

In FIG. 17, an encode sequence corresponding to encode step 585 is shown involving the hardware components: AI2S data link 568, BI2S data link 588, AYUVE data bus 567, BYUVI data bus 587, first DDR memory 589, a codec configured and operating as encoder ENC 590, second DDR memory 591, BMPEGE data bus 592, BMPEG_E data bus 593 and VioIP engine 594. Time progresses downward in the drawing. At step 584, uncompressed video data on AYUVE data bus 567 is transmitted through the primary FPGA to BYUVI data bus 587. At step 602, the DMA engine of the codec streams uncompressed video data from BYUVI data bus 587 into data buffer 603 of first DDR memory 589. At step 583, uncompressed audio data on AI2S data link 568 is transmitted through the primary FPGA to BI2S data link 588. At step 606, the DMA engine of the codec streams uncompressed audio data from BI2S data link 588 into data buffer 607 of first DDR memory 589. At step 610, ENC 590 encodes uncompressed audio and video data from data buffers 603 and 607 into a transport stream containing compressed A/V data which in step 611 is stored in data buffer 612 of second DDR memory 591. At step 613, the codec's DMA engine transmits the transport stream from data buffer 612 to BMPEGE data bus 592 where it is further transmitted to BMPEG_E data bus 593 after passing through the primary FPGA. The transport stream is further transferred from BMPEG_E data bus into VioIP engine where, in step 620, it is encapsulated into an IP data stream, packetized and sent to an IP network connected to an Ethernet port of the video TS/IP server.

If the video server block is configured to receive uncompressed YUV video from an external source, the uncompressed video and audio data is transferred from an SDI receiver to AYUVE data bus 567 at point 600 and AI2S data link at point 608, respectively. The SDI receiver can be configured to receive either an HD-SDI or DVB-ASI signal.

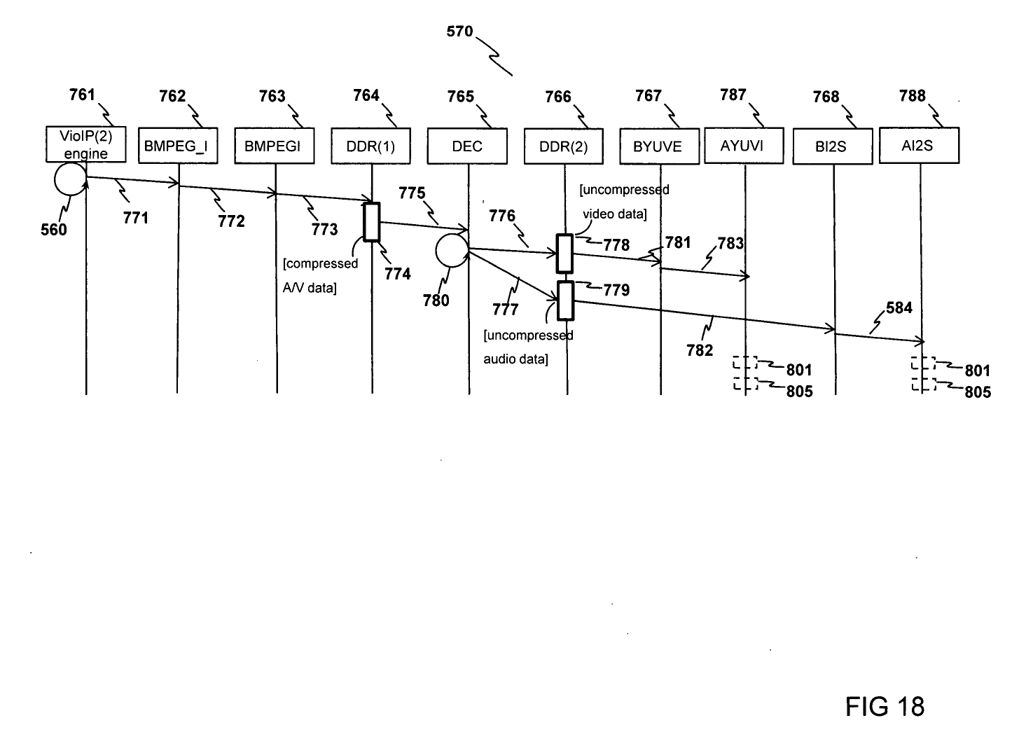

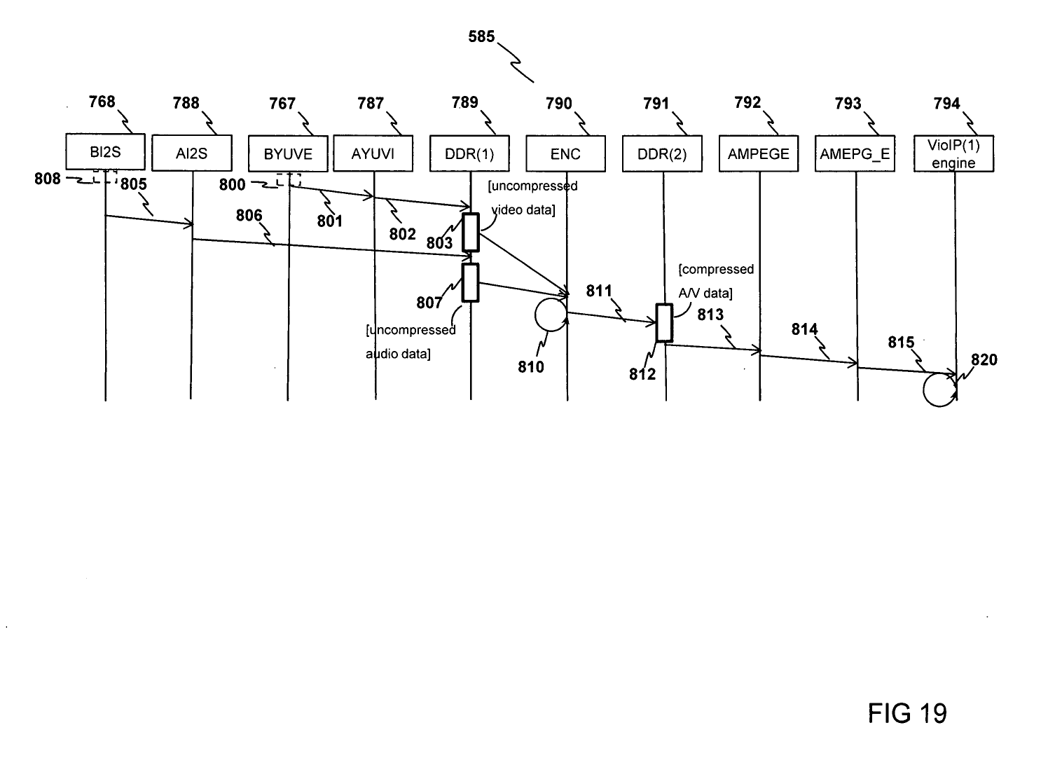

FIGS. 16 and 17 show the sequence of operations when the master codec is configured as the decoder and the slave codec is configured as the encoder. Equally valid operations are accomplished when the slave codec is configured as the decoder and master codec as the encoder, by exchanging the data buses BMPEGE and AMPEGE, BMPEG_E and AMPEG_E, BMPEGI and AMPEGI, BMPEG_I and AMPEG_I, AYUVE and BYUVE, AYUVI and BYUVI, and AI2S and BI2S. These alternate embodiments are depicted in FIGS. 18 and 19.

Continuing with FIG. 18, a decode sequence corresponding to decode step 570 is shown involving the hardware components: VioIP engine 761, BMPEG_I data bus 762, BMPEGI data bus 763, first DDR memory 764, a codec configured and operating as decoder DEC 765, second DDR memory 766, BYUVE data bus 767, AYUVI data bus 787, BI2S data link 768 and AI2S data link 788. Time progresses downward in the drawing. Decode step 570 begins just after step 560 when a compressed A/V data stream is received as an IP packet stream from an IP network connected to an Ethernet port of the video TS/IP server. VioIP engine 761 deserializes the IP packet stream and separates out the transport stream which appears in step 771 on BMPEG_I data bus 762. Data on the BMPEG_I data bus appears on the BMPEGI data bus in step 772 as configured in the primary FPGA. In step 773, the DMA engine of the codec streams data from the BMPEGI data bus into data buffer 774. In step 775, decoder DEC 765 extracts video and audio data from data buffer 774 and in step 780 decodes the video and audio data into an uncompressed YUV video data stream and an uncompressed audio data stream. At step 776, the uncompressed YUV video data stream is stored in data buffer 778. At step 777, the uncompressed audio data stream is stored in data buffer 779. At step 781, data buffer 578 is transmitted by the DMA engine to BYUVE data bus 767. At step 782, data buffer 779 is moved by the DMA engine to BI2S data link 768. At step 783, uncompressed video data appearing on BYUVE data bus is forwarded to the AYUVI bus and at step 784, uncompressed audio data appearing on BI2S data link is forwarded to the AI2S data link. At step 801, the uncompressed video and audio data can be captured by a second codec for encoding. If the video server block is configured for uncompressed YUV video output, the uncompressed video and audio data is transferred from the AYUVI bus and AI2S data link to an SDI transmitter at step 805. The SDI transmitter can be configured to transmit according to the HD-SDI or the DVB-ASI standard.

In FIG. 19, an encode sequence corresponding to encode step 585 is shown involving the hardware components: BI2S data link 768, AI2S data link 788, BYUVE data bus 767, AYUVI data bus 787, first DDR memory 789, a codec configured and operating as encoder ENC 790, second DDR memory 791, AMPEGE data bus 792, AMPEG_E data bus 793 and VioIP engine 794. Time progresses downward in the drawing. At step 784, uncompressed video data on AYUVE data bus 767 is transmitted through the primary FPGA to AYUVI data bus 787. At step 802, the DMA engine of the codec streams uncompressed video data from AYUVI data bus 787 into data buffer 803 of first DDR memory 789. At step 783, uncompressed audio data on BI2S data link 768 is transmitted through the primary FPGA to AI2S data link 788. At step 806, the DMA engine of the codec streams uncompressed audio data from AI2S data link 788 into data buffer 807 of first DDR memory 789. At step 810, ENC 790 encodes uncompressed audio and video data from data buffers 803 and 807 into a transport stream containing compressed AN data which in step 811 is stored in data buffer 812 of second DDR memory 791. At step 813, the codec's DMA engine transmits the transport stream from data buffer 812 to AMPEGE data bus 792 where it is further transmitted to AMPEG E data bus 793 after passing through the primary FPGA. The transport stream is further transferred from AMPEG_E data bus into VioIP engine where, in step 820, it is encapsulated into an IP data stream, packetized and sent to an IP network connected to an Ethernet port of the video TS/IP server.

If the video server block is configured to receive uncompressed YUV video from an external source, the uncompressed video and audio data is transferred from an SDI receiver to BYUVE data bus 767 at point 800 and BI2S data link at point 808, respectively. The SDI receiver can be configured to receive either an HD-SDI or DVB-ASI signal.

The foregoing descriptions of configuring and processing a video stream for a video server block, including encoding and decoding functions, is repeated for each video server block contained within a video TS/IP server. For the stand-alone embodiment of the video TS/IP server, for example, four configurations and four video streams are processed simultaneously having an input and output defined for each video stream. The foregoing descriptions are also not intended to limit the number of video streams processed simultaneously by a video server block. It is expected that the DSP processing and DMA capability of future codec devices will support simultaneous processing of multiple HD-SDI, MPEG2, H.264, DV25 and DVC-pro/25/50/100 based transport streams. It is within the capability of the existing hardware to process multiple MPEG2 transport streams. It is therefore within the scope of the present invention, with the video server hardware embodiments as described, to simultaneously process multiple video streams through a single video server block.

Other embodiments may be conceived, for example, for current and future studio quality video formats which may include 3-D image and video content of current and future consumer formats. Still other embodiments may be conceived, that combine larger numbers of video server blocks together to provide a higher capacity video TS/IP server. Another embodiment may be conceived whereby a stand-alone video TS/IP server incorporates a single video server block with video I/O over Ethernet ports only. Another embodiment may be conceived whereby multiple PCI hosted video TS/IP servers are installed into a host computer server and wherein the host computer software provides a management function for all installed video TS/IP servers. The specifications and description described herein are not intended to limit the invention, but to simply show a set of embodiments in which the invention may be realized.

1. A video transport stream server comprising:
a set of video server blocks, each video server block in the set of video server blocks further comprising:
a first codec implemented on a single-chip multi-core processor having a system function core operating a system OS and a digital signal processing core operating a DSP OS;
a second codec implemented on a single-chip multi-core processor having a system function core operating a system OS and a digital signal processing core operating a DSP OS;
a first Ethernet PHY interface connected to the first codec and a second Ethernet PHY interface connected to the second codec;
a first DDR memory attached to the first codec and a second DDR memory attached to the second codec;
a primary FPGA connected by a first set of data and control buses to the first codec and connected by a second set of data and control buses to the second codec, and further connected to a first non-volatile memory device;
a first VioIP processor for encapsulating a video transport stream into an IP packet stream, the first VioIP processor connected to the first codec for control, connected to the primary FPGA via a third data and control bus, and further connected to a third Ethernet PHY interface;
a first VioIP memory accessible by the first VioIP processor, comprising volatile and non-volatile memory;
a second VioIP processor for encapsulating a video transport stream into an IP packet stream, the second VioIP processor connected to the second codec for control, connected to the primary FPGA via a third data and control bus, and further connected to a fourth Ethernet PHY interface;
a second VioIP memory accessible by the second VioIP processor, comprising volatile and non-volatile memory;

2. The video transport stream server of claim 1 wherein
the first set of data and control buses comprising a first bidirectional bus capable to transport uncompressed video streams, a second bidirectional bus capable to transport compressed audio and video data streams, and a first I2S bus; and,
the second set of data and control buses comprising a third bidirectional bus capable to transport uncompressed video streams, a fourth bidirectional bus capable to transport compressed audio and video data streams, and a second I2S bus.

3. The video transport stream server of claim 1 wherein
the first non-volatile memory contains program instructions for performing a video processing operation on the first and second codecs and for transforming an input audio and video data stream to an output audio and video data stream on the first and the second codecs.

4. The video transport stream server of claim 3 wherein
the input audio and video data stream is in a compressed format; and,
the output audio and video data stream comprises a first substream in an uncompressed video format and a second substream in an uncompressed audio format.

5. The video transport stream server of claim 3 wherein
the input audio and video data stream comprises a first substream in an uncompressed video format and a second substream in an uncompressed audio format; and,
the output audio and video data stream is in a compressed format;

6. The video transport stream server of claim 4 wherein
the compressed format includes at least one format selected from the group: MPEG2, H.264, DV25 and DVC-pro/25/50/100.

7. The video transport stream server of claim 5 wherein the compressed format includes at least one format selected from the group: MPEG2, H.264, DV25 and DVC-pro/25/50/100.

8. The video transport stream server of claim 1 further comprising
a digital video receiver connected to the first set of data and control buses;
the digital video receiver further connected to an adaptive cable equalizer;
the adaptive cable equalizer connected to a coaxiable cable carrying uncompressed audio and video data; and,
the digital video receiver for receiving and de-serializing the uncompressed audio and video data in at least one of HD-SDI and DVB-ASI formats.

9. The video transport stream server of claim 1 further comprising
a digital video transmitter connected to the second set of data and control buses and a coaxiable cable, for serializing and transmitting on the coaxiable cable, an uncompressed audio and video data in at least one of HD-SDI and DVB-ASI formats.

10. The video transport stream server of claim 1, wherein the primary FPGA comprises:
a first multiplexer selectably interconnecting a first pair of input data and control buses carrying compressed audio and video data to a first pair of output data and control buses;
a second multiplexer selectably interconnecting a second pair of input data and control buses suitable for compressed AN data to a second pair of output data and control buses also suitable for compressed AN data.
a third multiplexer selectably interconnecting a flash memory data and address bus to one of a first stream loader and a second stream loader;
the first stream loader being connected to the third multiplexer and further connected to a first input data and control bus carrying uncompressed video data, and connected to a first output data and control bus; wherein,
the first stream loader is selectably configured to pass data selected from one of the first input data and control bus and the third multiplexer, to the first output data and control bus;
the second stream loader being connected to the third multiplexer and further connected to a second input data and control bus carrying uncompressed video data, and connected to a second output data and control bus; and wherein,
the second stream loader is selectably configured to pass data selected from one of the second input data and control bus and the third multiplexer, to the second output data and control bus.

11. The video transport stream server of claim 1 wherein the set of video server blocks has N video server blocks, the video transport server further comprising:
a host processor connected to a flash memory, a random access memory, a set of status indicators, and a set of Ethernet ports;
an Ethernet switch having a first set of 2N Ethernet ports connected to the set of video server blocks for transmitting and receiving transport streams over internet protocol, and further having a second set of Ethernet ports which are connected to the host processor.
an uncompressed video signal multiplexer connected to the host processor for control, comprising a 2N port by 2N port digital multiplexer where any one of N/2 external input lines can be selectable connected to any one of N internal output lines and any one of N external output lines can be selectably connected to any one of N internal input lines; and where the N internal input lines and N internal output lines are connected to the N video server blocks; and,
a dual redundant power supply with a power switch and a power input connector which supplies power to the N video server blocks, the host processor, the Ethernet switch and the uncompressed video signal multiplexer.

12. The video transport stream server of claim 11 which further comprises a web application operating on the host processor to enable configuration of the video server blocks and the uncompressed video signal multiplexer over an IP network.

13. The video transport server of claim 1 wherein the set of video server blocks has one video server block and further comprises:
a PCI bus connected to the first and second codec of the one video server block;
a host computer having a PCIe bus;
a PCI to PCIe converter interconnecting the PCI bus to the PCIe bus to allow for communications between the host computer and the video transport server; and,
a user interface program operating on the host computer to allow configuration of the video transport server.

14. The apparatus of claim 13 wherein the host computer is connected to a plurality of video transport server cards via the PCIe bus and where each video transport server card is configured the same as the video transport server.

15. A method for transcoding and transrating a video transport stream using a video transport stream server having a set of video server blocks, with each video server block including a first codec, a second codec, a primary FPGA connecting to the first and second codecs, a first VioIP processor connected to the primary FPGA and controlled by the first codec, a second VioIP processor connected to the primary FPGA and controlled by the second codec, and where the first and second VioIP processors are connected to an IP network; each video server block further connected to a host processor which is operating a configuration program, the method comprising the steps of:
initiating a video server block;
waiting for changes to encoding and decoding tasks;
defining the encoding and decoding tasks for the video server block using the configuration program;
configuring an input transport stream on an input port as a first codec configuration;
configuring an output transport stream on an output port as a second codec configuration according to the encoding and decoding tasks;
configuring the primary FPGA to enable data flow of an intermediate data stream from the first codec to the second codec via the primary FPGA;
enabling data flow of the input transport stream from the input port to the first codec via the first VioIP processor;
enabling data flow of the output transport stream from the second codec to the output port via the second VioIP processor;
receiving from an IP network, the input transport stream on the input port as a compressed audio and video data stream;
storing the compressed audio and video data stream into a first buffer;
decoding the compressed audio and video data stream into an uncompressed audio data stream and an uncompressed video data stream according to the first codec configuration;
storing the uncompressed audio and video data streams into a second buffer;
encoding the uncompressed audio data stream and the uncompressed video data stream from the second buffer into a second compressed audio and video data stream according to the second codec configuration; and,
transmitting to an IP network, the second compressed audio/video data stream as the output transport stream on the output port.

16. The method of claim 15 including an additional step of selecting a second video coding format in the second codec configuration different from a first video coding format in the first codec configuration.

17. The method of claim 15 including an additional step of selecting a second compression level in the second codec configuration different from a compression level in the first codec configuration.

18. The method of claim 15 where the initiating step further comprises the steps of:
configuring the primary FPGA to connect non-volatile memory to the first codec using a high speed digital video data bus;
powering the video transport stream server on;
loading codec program instructions from the non-volatile memory into the first codec;
executing the codec program instructions on the first codec;
reconfiguring the primary FPGA to connect the non-volatile memory to the second codec;
releasing the second codec to operate;
loading the codec program instructions from the non-volatile memory into the second codec;
executing the codec program instructions on the second codec; and,
reconfiguring the primary FPGA to connect the high speed digital video data bus between the first and second codecs.

19. A method for transcoding and transrating a video transport stream using a video transport stream server having a set of video server blocks, with each video server block including a first codec, a second codec, a primary FPGA connecting to the first and second codecs, a first VioIP processor connected to the primary FPGA and controlled by the first codec, a second VioIP processor connected to the primary FPGA and controlled by the second codec, and where the first VioIP processor is connected to an IP network via a first Ethernet port and a second VioIP processor is connected to an IP network via a second Ethernet port; an SDI receiver connected to the primary FPGA and to a first coaxial cable via an adaptive cable equalizer; an SDI transmitter connected between a second coaxial cable and the primary FPGA, and wherein each video server block further is connected to a host processor which is operating a configuration program, the method comprising the steps of:
initiating a video server block;
waiting for changes to encoding and decoding tasks;
defining the encoding and decoding tasks for the video server block using the configuration program;
configuring an input transport stream on an input port where the input port is selected from the one of the first Ethernet port and the SDI receiver;
configuring an output transport stream on an output port where the output port is selected from the one of the second Ethernet port and the SDI transmitter;
configuring the primary FPGA to enable data flow of an intermediate data stream from the first codec to the second codec via the primary FPGA;
if the input port is selected as the first Ethernet port, then performing the decoding steps including:
enabling data flow of the input transport stream from the input port to the first codec via the first VioIP processor;
receiving the input transport stream on the input port as a compressed audio and video data stream;
storing the compressed audio and video data stream into a first buffer;
decoding the compressed audio and video data stream into an uncompressed audio data stream and an uncompressed video data stream according to the defined encoding and decoding tasks;
storing the uncompressed audio and video data streams into a second buffer;
if the input port is selected as the SDI receiver, then transferring an uncompressed audio and video data stream into a second buffer;
if the output port is selected as the second Ethernet port, then performing the encoding steps of:
enabling data flow of the output transport stream from the second codec to the output port via the second VioIP processor;
encoding the uncompressed audio data stream and the uncompressed video data stream from the second buffer into a second compressed audio and video data stream according to the encoding and decoding tasks; and,
transmitting to an IP network, the second compressed audio/video data stream as the output transport stream on the output port;
if the output port is selected as the SDI transmitter, then transmitting the uncompressed audio and video data streams from the second buffer to the SDI transmitter.

20. The method of claim 19 wherein the SDI receiver is configured to receive HD-SDI video signals.

21. The method of claim 19 wherein the SDI receiver is configured to receive DVB-ASI video signals.

22. The method of claim 19 wherein the SDI transmitter is configured to transmit HD-SDI video signals.

23. The method of claim 19 wherein the SDI transmitter is configured to transmit DVB-ASI video signals.
